(19) United States
(12) Patent Application Publication
(10) Pub. No.: US 2008/0279137 A1
(43) Pub. Date: Nov. 13, 2008

(54) DISCONTINUOUS INQUIRY FOR WIRELESS COMMUNICATION

(75) Inventors: Ville Pernu, Tampere (FI); Jussi Ylanen, Lempaala (FI); Jani Okker, Tampere (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/746,962

(22) Filed: May 10, 2007

(51) Int. Cl. H04Q 7/00

(52) U.S. Cl. 370/328; 455/552.1

(57) ABSTRACT

A system for managing the operation of a plurality of wireless communication mediums supported by one or more radio modules integrated within a wireless communication device. A control strategy may be employed to regulate the operation of at least one wireless communication medium operating in a continuous mode, such as an discovery or inquiry mode, so as not to conflict with other active communication occurring substantially simultaneously within the wireless communication device. The regulation may occur in the one or more radio modules, and may include rescheduling part of, or alternatively a whole, discovery hop train.

### BACKGROUND OF INVENTION

1. Field of Invention

The present invention relates to a system for managing radio modules integrated within a wireless communication device, and more specifically, to a multiradio control system enabled to create an operational schedule for two or more concurrently operating radio modules, wherein a radio module having local control may manage unscheduled communication in view of various inputs.

2. Description of Prior Art

Modern society has quickly adopted, and become reliant upon, handheld devices for wireless communication. For example, cellular telephones continue to proliferate in the global marketplace due to technological improvements in both the quality of the communication and the functionality of the devices. These wireless communication devices (WCDs) have become commonplace for both personal and business use, allowing users to transmit and receive voice, text and graphical data from a multitude of geographic locations. The communication networks utilized by these devices span different frequencies and cover different transmission distances, each having strengths desirable for various applications.

Cellular networks facilitate WCD communication over large geographic areas. These network technologies have commonly been divided by generations, starting in the late 1970s to early 1980s with first generation (1G) analog cellular telephones that provided baseline voice communication, to modern digital cellular telephones. GSM is an example of a widely employed 2G digital cellular network communicating in the 900 MHz/1.8 GHz bands in Europe and at 850 MHz and 1.9 GHz in the United States. This network provides voice communication and also supports the transmission of textual data via the Short Messaging Service (SMS). SMS allows a WCD to transmit and receive text messages of up to 160 characters, while providing data transfer to packet networks, ISDN and POTS users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth™ is an example of a short-range wireless technology quickly gaining acceptance in the marketplace. A 1 Mbps Bluetooth™ radio may transmit and receive data at a rate of 720 Kbps within a range of 10 meters, and may transmit up to 100 meters with additional power boosting. Enhanced data rate (EDR) technology also available may enable maximum asymmetric data rates of 1448 Kbps for a 2 Mbps connection and 2178 Kbps for a 3 Mbps connection. A user does not actively instigate a Bluetooth™ network. Instead, a plurality of devices within operating range of each other may automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master. These devices continually switch between various active communication and power saving modes in order to transmit data to other piconet members. In addition to Bluetooth™ other popular short-range wireless networks include WLAN (of which “Wi-Fi” local access points communicating in accordance with the IEEE 802.11 standard, is an example), WUSB, UWB, ZigBee (802.15.4, 802.15.4a), and UHF RFID. All of these wireless mediums have features and advantages that make them appropriate for various applications.

More recently, manufacturers have also begun to incorporate various resources for providing enhanced functionality in WCDs (e.g., components and software for performing close-proximity wireless information exchanges). Sensors and/or scanners may be used to read visual or electronic information into a device. A transaction may involve a user holding their WCD in proximity to a target, aiming their WCD at an object (e.g., to take a picture) or sweeping the device over a printed tag or document. Near Field communication (NFC) technologies include machine-readable mediums such as radio frequency identification (RFID), Infra-red (IR) communication, optical character recognition (OCR) and various other types of visual, electronic and magnetic scanning are used to quickly input desired information into the WCD without the need for manual entry by a user.

Device manufacturers continue to incorporate as many of the previously discussed exemplary communication features as possible into wireless communication devices in an attempt to bring powerful, “do-all” devices to market. Devices incorporating long-range, short-range and NFC resources often include multiple mediums for each category. This may allow a WCD to flexibly adjust to its surroundings, for example, communicating both with a WLAN access point and a Bluetooth™ communication accessory, possibly at the same time.

Given the large array communication features that may be compiled into a single device, it is foreseeable that a user will need to employ a WCD to its full potential when replacing other productivity related devices. For example, a user may utilize a fully-functioned WCD to replace traditional tools such as individual phones, facsimile machines, computers, storage media, etc. which tend to be cumbersome to both integrate and transport. In at least one use scenario, a WCD may be communicating simultaneously over numerous different wireless mediums. A user may utilize multiple peripheral Bluetooth™ devices (e.g., a headset and a keyboard) while having a voice conversation over GSM and interacting with a WLAN access point in order to access the Internet. Problems may occur when these concurrent transactions cause interference with each other. Even if a communication medium does not have an identical operating frequency as another medium, a radio modem may cause extraneous interference to another medium. Further, it is possible for the combined effects of two or more simultaneously operating radios to create intermodulation effects to another bandwidth due to harmonic effects. These disturbances may cause errors resulting in the required retransmission of lost packets, and the overall degradation of performance for one or more communication mediums.

More specifically, some modes of operation in a wireless communication medium may be resource intensive, effectively blocking out the ability of other wireless communication mediums operating in the same similar frequency range to transmit and/or receive at the same time. An example of such a mode is Bluetooth™ device discovery process. Bluetooth™ discovery is an inquiry mechanism that may be utilized to request and receive the address, clock, class of device and used page scan mode information of other Bluetooth™-enabled devices. This information may be used to pair a device (e.g., a headset, keyboard or another Bluetooth™-enabled device) with a WCD in a relationship wherein information is exchanged so that the secondary device may be readily recognized and then wirelessly linked with a WCD.

In an exemplary Bluetooth™ inquiry operation, two different frequency hop trains may be used, during which 32 frequencies are inquired. Each hop train, which covers 16 frequencies, is 10 ms in length and needs to be repeated at least 256 times before a switch is done. At least three train switches must be executed in order to find all other Bluetooth™ devices within range. Thus, an inquiry operation may last at least 10.24 seconds. During this period of time, any other potentially conflicting wireless communication medium supported by one or more radio modules integrated within a WCD may be unable to communicate. The interference created in this situation may be very problematic in view of WCD operation because the Bluetooth™ device discovery continuously utilizes such a substantial amount of time, resulting in a communication disruption for other resources also incorporated in a WCD.

What is therefore needed is a system for managing wireless resources in the same wireless communication device that utilize potentially conflicting wireless communication mediums. The management system should be able to account for a wireless communication medium utilizing a substantial amount of the available time, for example, when operating in a certain communication mode. In accounting for this mode of operation, the system should both evaluate if the extensive time usage may present a problem (e.g., a conflict or interference), and if a potential problem exists, the system should further be able to modify the operation of at least one wireless communication medium operating in the certain communication mode in order to avoid any potential conflicts while still maintaining stable communication in all of the active wireless communication mediums currently being utilized in the wireless communication device.

### SUMMARY OF INVENTION

The present invention includes at least a method, device, computer program and radio module used for managing the operation of a plurality of wireless communication mediums supported by one or more radio modules integrated within a WCD. In at least one embodiment of the present invention, a control strategy may be employed to regulate the operation of at least one wireless communication medium operating in a continuous mode, such as an discovery or inquiry mode, so as not to conflict with other active communication occurring substantially simultaneously within the WCD. The regulation may occur in the one or more radio modules.

For example, a WCD may have at least two active wireless communication mediums operating in a substantially simultaneous manner. At least one of these wireless communication mediums may be operating in a continuous mode, such as in the performance of a device discovery. Control resources in the device may sense potential conflicts between the wireless communication mediums, and as a result, adjust the operation of any wireless communication medium operating in a continuous mode to include gaps of time during which other wireless communication mediums may conduct stable operations without interference.

The adjustment to the operation of the at least two wireless communication mediums may occur, for example, by altering an operational schedule pertaining to each wireless communication medium, and sending the altered operational schedules to the one or more radio modules supporting the wireless communication mediums. In accordance with at least one embodiment of the present invention, the altered operational schedules may, for example, cancel certain timeslots in a conflicting hop train, cancel an entire conflicting hop train, or make other changes in order to reschedule the at least one wireless communication medium operating in a continuous mode so as not to conflict with other active wireless communication mediums.

### DESCRIPTION OF DRAWINGS

The invention will be further understood from the following detailed description of a preferred embodiment, taken in conjunction with appended drawings, in which:

FIG. 1 discloses an exemplary wireless operational environment, including wireless communication mediums of different effective range.

FIG. 2 discloses a modular description of an exemplary wireless communication device usable with at least one embodiment of the present invention.

FIG. 3 discloses an exemplary structural description of the wireless communication device previously described in FIG. 2.

FIG. 4A discloses an exemplary operational description of a wireless communication device utilizing a wireless communication medium in accordance with at least one embodiment of the present invention.

FIG. 4B discloses an operational example wherein interference occurs when utilizing multiple radio modems simultaneously within the same wireless communication device.

FIG. 5A discloses an example of single mode radio modules usable with at least one embodiment of the present invention.

FIG. 5B discloses an example of a multimode radio module usable with at least one embodiment of the present invention.

FIG. 6A discloses an exemplary structural description of a wireless communication device including a multiradio controller in accordance with at least one embodiment of the present invention.

FIG. 6B discloses a more detailed structural diagram of FIG. 6A including the multiradio controller and the radio modems.

FIG. 6C discloses an exemplary operational description of a wireless communication device including a multiradio controller in accordance with at least one embodiment of the present invention.

FIG. 7A discloses an exemplary structural description of a wireless communication device including a multiradio control system in accordance with at least one embodiment of the present invention.

FIG. 7B discloses a more detailed structural diagram of FIG. 7A including the multiradio control system and the radio modems.

FIG. 7C discloses an exemplary operational description of a wireless communication device including a multiradio control system in accordance with at least one embodiment of the present invention.

FIG. 8A discloses an exemplary structural description of a wireless communication device including a distributed multiradio control system in accordance with at least one embodiment of the present invention.

FIG. 8B discloses a more detailed structural diagram of FIG. 8A including the distributed multiradio control system and the radio modems.

FIG. 8C discloses an exemplary operational description of a wireless communication device including a distributed multiradio control system in accordance with at least one embodiment of the present invention.

FIG. 9A discloses an exemplary structural description of a wireless communication device including a distributed multiradio control system in accordance with an alternative embodiment of the present invention.

FIG. 9B discloses a more detailed structural diagram of FIG. 9A including the distributed multiradio control system and the radio modems.

FIG. 9C discloses an exemplary operational description of a wireless communication device including a distributed multiradio control system in accordance with the alternative embodiment of the present invention disclosed in FIG. 9A.

FIG. 10 discloses an exemplary information packet usable with at least one embodiment of the present invention.

FIG. 11A discloses an example of avoiding a potential conflict by canceling an entire hop train in accordance with at least one embodiment of the present invention.

FIG. 11B discloses an example of avoiding a potential conflict by partially canceling a hop train in accordance with at least one embodiment of the present invention.

FIG. 11C discloses an example of rescheduling a hop train to execute later in time in accordance with at least one embodiment of the present invention.

FIG. 12 discloses an exemplary implementation of the present invention without a dedicated multiradio controller in accordance with at least one embodiment of the present invention.

FIG. 13 discloses an exemplary flowchart for a process controlling the adjustment of a wireless communication medium operating in a continuous discovery mode in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

### I. Wireless Communication Over Different Communication Networks

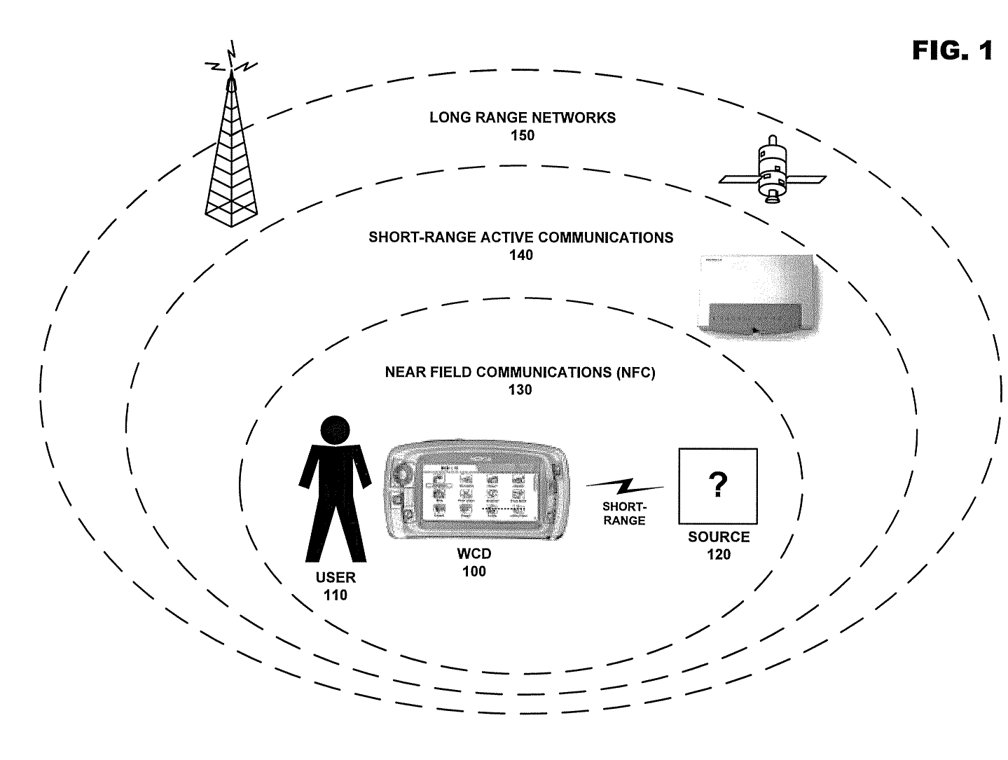

A WCD may both transmit and receive information over a wide array of wireless communication networks, each with different advantages regarding speed, range, quality (error correction), security (encoding), etc. These characteristics will dictate the amount of information that may be transferred to a receiving device, and the duration of the information transfer. FIG. 1 includes a diagram of a WCD and how it interacts with various types of wireless networks.

In the example pictured in FIG. 1, user 110 possesses WCD 100. This device may be anything from a basic cellular handset to a more complex device such as a wirelessly enabled palmtop or laptop computer. Near Field Communication (NFC) 130, in accordance with at least one embodiment of the present invention, may include various transponder-type interactions wherein normally only the scanning device requires its own power source. WCD 100 scans source 120 via short-range communication. A transponder in source 120 may use the energy and/or clock signal contained within the scanning signal, as in the case of RFID communication, to respond with data stored in the transponder. These types of technologies usually have an effective transmission range on the order of ten feet, and may be able to deliver stored data in amounts from a bit to over a megabit (or 125 Kbytes) relatively quickly. These features make such technologies well suited for identification purposes, such as to receive an account number for a public transportation provider, a key code for an automatic electronic door lock, an account number for a credit or debit transaction, etc.

The transmission range between two devices may be extended if both devices are capable of performing powered communication. Short-range active communication 140 includes applications wherein the sending and receiving devices are both active. An exemplary situation would include user 110 coming within effective transmission range of a Bluetooth™, WLAN, UWB, WUSB, etc. access point. In the case of Bluetooth™, a network may automatically be established to transmit information to WCD 100 possessed by user 110. This data may include information of an informative, educational or entertaining nature. The amount of information to be conveyed is unlimited, except that it must all be transferred in the time when user 110 is within effective transmission range of the access point. Due to the higher complexity of these wireless networks, additional time is also required to establish the initial connection to WCD 100, which may be increased if many devices are queued for service in the area proximate to the access point. The effective transmission range of these networks depends on the technology, and may be from some 30 ft. to over 300 ft. with additional power boosting.

Long-range networks 150 are used to provide virtually uninterrupted communication coverage for WCD 100. Land-based radio stations or satellites are used to relay various communication transactions worldwide. While these systems are extremely functional, the use of these systems is often charged on a per-minute basis to user 110, not including additional charges for data transfer (e.g., wireless Internet access). Further, the regulations covering these systems may cause additional overhead for both the users and providers, making the use of these systems more cumbersome.

### II. Wireless Communication Device

As previously described, the present invention may be implemented using a variety of wireless communication equipment. Therefore, it is important to understand the communication tools available to user 110 before exploring the present invention. For example, in the case of a cellular telephone or other handheld wireless devices, the integrated data handling capabilities of the device play an important role in facilitating transactions between the transmitting and receiving devices.

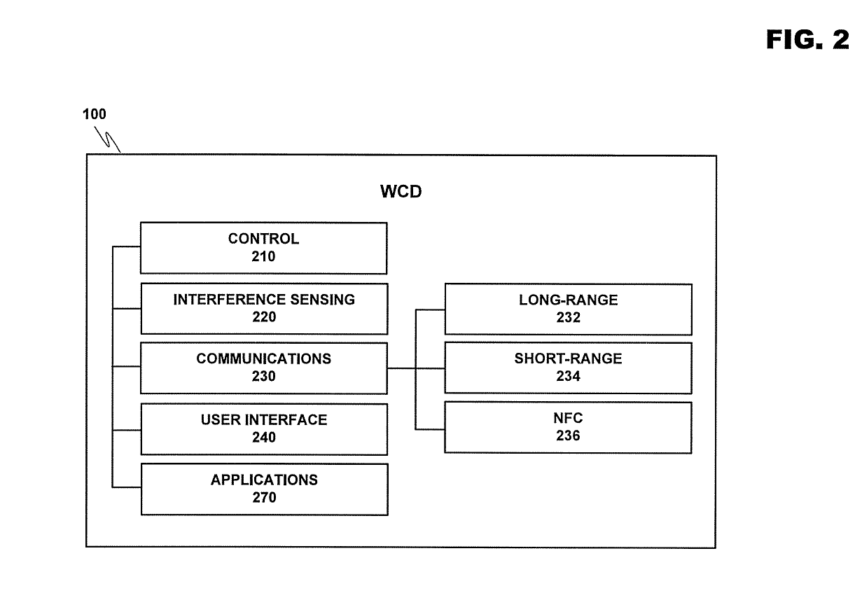

FIG. 2 discloses an exemplary modular layout for a wireless communication device usable with the present invention. WCD 100 is broken down into modules representing the functional aspects of the device. These functions may be performed by the various combinations of software and/or hardware components discussed below.

Control module 210 regulates the operation of the device. Inputs may be received from various other modules included within WCD 100. For example, interference sensing module 220 may use various techniques known in the art to sense sources of environmental interference within the effective transmission range of the wireless communication device. Control module 210 interprets these data inputs, and in response, may issue control commands to the other modules in WCD 100.

Communications module 230 incorporates all of the communication aspects of WCD 100. As shown in FIG. 2, communications module 230 may include, for example, long-range communications module 232, short-range communications module 234 and NFC module 236. Communications module 230 may utilize one or more of these sub-modules to receive a multitude of different types of communication from both local and long distance sources, and to transmit data to recipient devices within the transmission range of WCD 100. Communications module 230 may be triggered by control module 210, or by control resources local to the module responding to sensed messages, environmental influences and/or other devices in proximity to WCD 100.

User interface module 240 includes visual, audible and tactile elements which allow the user 110 to receive data from, and enter data into, the device. The data entered by user 110 may be interpreted by control module 210 to affect the behavior of WCD 100. User-inputted data may also be transmitted by communications module 230 to other devices within effective transmission range. Other devices in transmission range may also send information to WCD 100 via communications module 230, and control module 210 may cause this information to be transferred to user interface module 240 for presentment to the user.

Applications module 250 incorporates all other hardware and/or software applications on WCD 100. These applications may include sensors, interfaces, utilities, interpreters, data applications, etc., and may be invoked by control module 210 to read information provided by the various modules and in turn supply information to requesting modules in WCD 100.

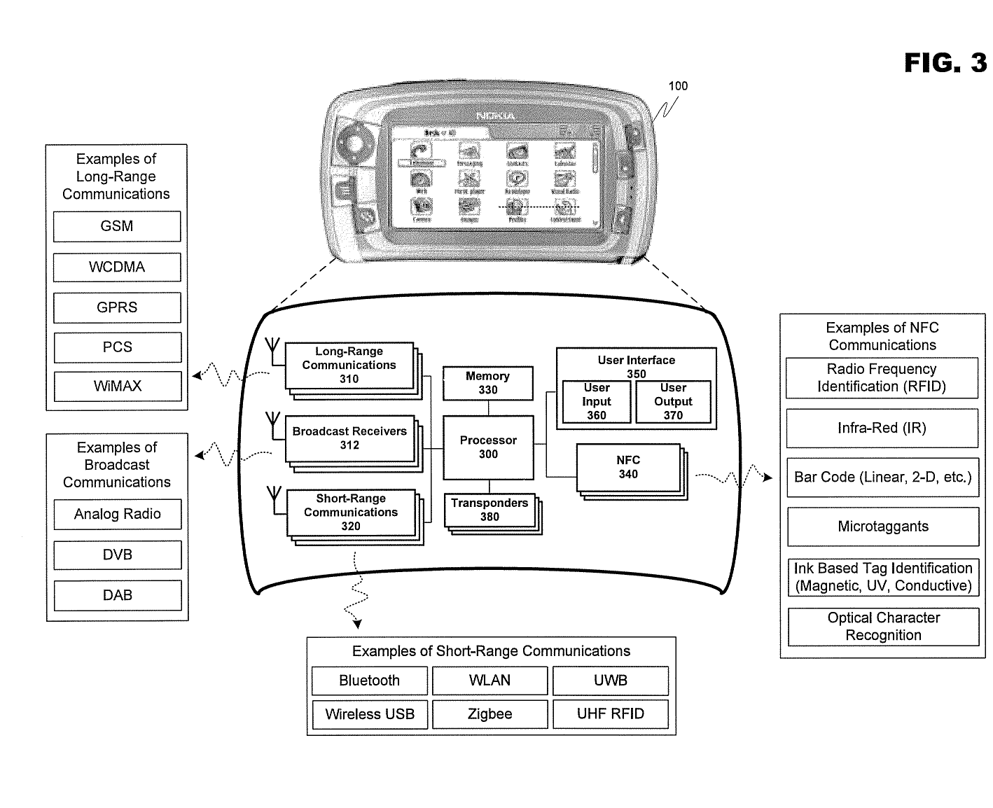

FIG. 3 discloses an exemplary structural layout of WCD 100 according to an embodiment of the present invention that may be used to implement the functionality of the modular system previously described in FIG. 2. Processor 300 controls overall device operation. As shown in FIG. 3, processor 300 is coupled to one or more communications sections 310, 320 and 340. Processor 300 may be implemented with one or more microprocessors that are each capable of executing software instructions stored in memory 330.

Memory 330 may include random access memory (RAM), read only memory (ROM), and/or flash memory, and stores information in the form of data and software components (also referred to herein as modules). The data stored by memory 330 may be associated with particular software components. In addition, this data may be associated with databases, such as a bookmark database or a business database for scheduling, email, etc.

The software components stored by memory 330 include instructions that can be executed by processor 300. Various types of software components may be stored in memory 330. For instance, memory 330 may store software components that control the operation of communication sections 310, 320 and 340. Memory 330 may also store software components including a firewall, a service guide manager, a bookmark database, user interface manager, and any communication utilities modules required to support WCD 100.

Long-range communications 310 performs functions related to the exchange of information over large geographic areas (such as cellular networks) via an antenna. These communication methods include technologies from the previously described 1G to 3G. In addition to basic voice communication (e.g., via GSM), long-range communications 310 may operate to establish data communication sessions, such as General Packet Radio Service (GPRS) sessions and/or Universal Mobile Telecommunications System (UMTS) sessions. Also, long-range communications 310 may operate to transmit and receive messages, such as short messaging service (SMS) messages and/or multimedia messaging service (MMS) messages.

As a subset of long-range communications 310, or alternatively operating as an independent module separately connected to processor 300, transmission receiver 312 allows WCD 100 to receive transmission messages via mediums such as Digital Video Broadcast for Handheld Devices (DVB-H). These transmissions may be encoded so that only certain designated receiving devices may access the transmission content, and may contain text, audio or video information. In at least one example, WCD 100 may receive these transmissions and use information contained within the transmission signal to determine if the device is permitted to view the received content.

Short-range communications 320 is responsible for functions involving the exchange of information across short-range wireless networks. As described above and depicted in FIG. 3, examples of such short-range communications 320 are not limited to Bluetooth™, WLAN, UWB and Wireless USB connections. Accordingly, short-range communications 320 performs functions related to the establishment of short-range connections, as well as processing related to the transmission and reception of information via such connections.

NFC 340, also depicted in FIG. 3, may provide functionality related to the short-range scanning of machine-readable data. For example, processor 300 may control components in NFC 340 to generate RF signals for activating an RFID transponder, and may in turn control the reception of signals from an RFID transponder. Other short-range scanning methods for reading machine-readable data that may be supported by the NFC 340 are not limited to IR communication, linear and 2-D (e.g., QR) bar code readers (including processes related to interpreting UPC labels), and optical character recognition devices for reading magnetic, UV, conductive or other types of coded data that may be provided in a tag using suitable ink. In order for the NFC 340 to scan the aforementioned types of machine-readable data, the input device may include optical detectors, magnetic detectors, CCDs or other sensors known in the art for interpreting machine-readable information.

As further shown in FIG. 3, user interface 350 is also coupled to processor 300. User interface 350 facilitates the exchange of information with a user. FIG. 3 shows that user interface 350 includes a user input 360 and a user output 370. User input 360 may include one or more components that allow a user to input information. Examples of such components include keypads, touch screens, and microphones. User output 370 allows a user to receive information from the device. Thus, user output portion 370 may include various components, such as a display, light emitting diodes (LED), tactile emitters and one or more audio speakers. Exemplary displays include liquid crystal displays (LCDs), and other video displays.

WCD 100 may also include one or more transponders 380. This is essentially a passive device that may be programmed by processor 300 with information to be delivered in response to a scan from an outside source. For example, an RFID scanner mounted in an entryway may continuously emit radio frequency waves. When a person with a device containing transponder 380 walks through the door, the transponder is energized and may respond with information identifying the device, the person, etc. In addition, a scanner may be mounted (e.g., as previously discussed above with regard to examples of NFC 340) in WCD 100 so that it can read information from other transponders in the vicinity.

Hardware corresponding to communications sections 310, 312, 320 and 340 provide for the transmission and reception of signals. Accordingly, these portions may include components (e.g., electronics) that perform functions, such as modulation, demodulation, amplification, and filtering. These portions may be locally controlled, or controlled by processor 300 in accordance with software communication components stored in memory 330.

The elements shown in FIG. 3 may be constituted and coupled according to various techniques in order to produce the functionality described in FIG. 2. One such technique involves coupling separate hardware components corresponding to processor 300, communications sections 310, 312 and 320, memory 330, NFC 340, user interface 350, transponder 380, etc. through one or more bus interfaces (which may be wired or wireless bus interfaces). Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 350 may interact with a communication utilities software component, also contained in memory 330, which provides for the establishment of service sessions using long-range communications 310 and/or short-range communications 320. The communication utilities component may include various routines that allow the reception of services from remote devices according to mediums such as the Wireless Application Medium (WAP), Hypertext Markup Language (HTML) variants like Compact HTML (CHTML), etc.

### III. Exemplary Operation of a Wireless Communication Device Including Potential Interference Problems Encountered.

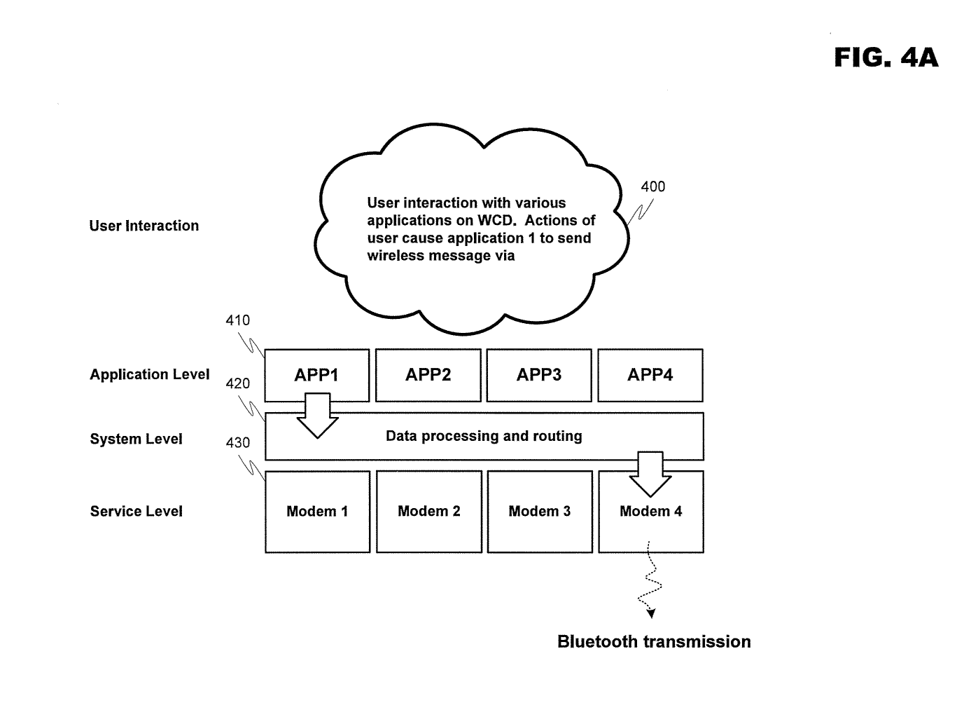

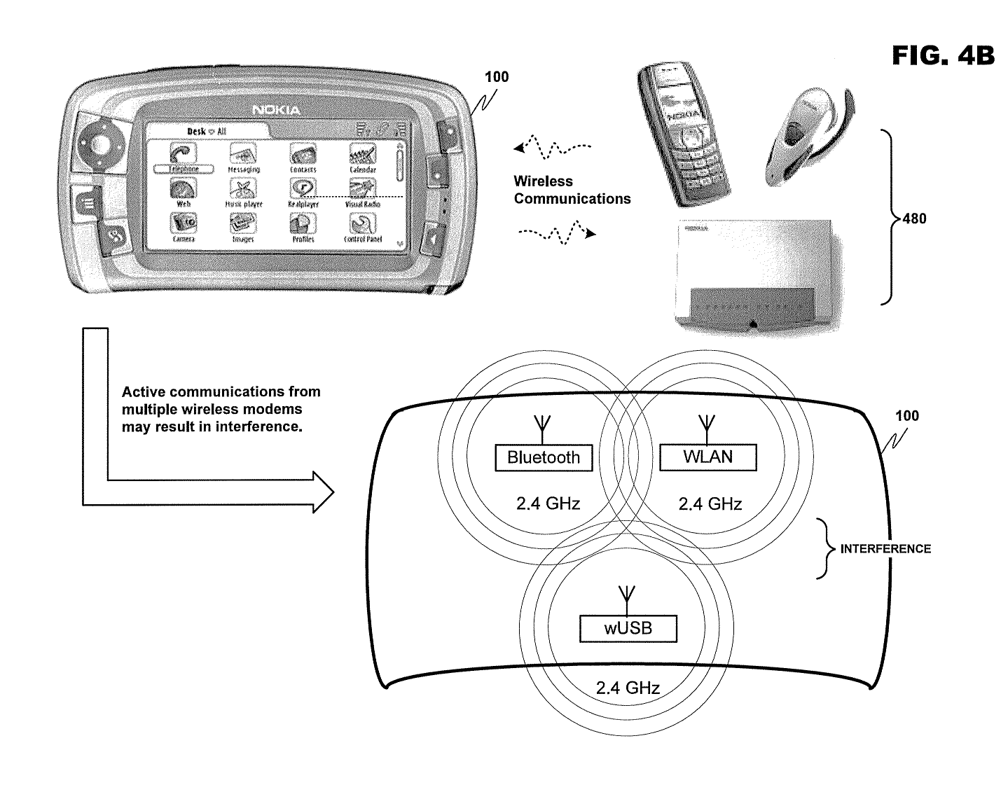

FIG. 4A discloses a stack approach to understanding the operation of a WCD in accordance with at least one embodiment of the present invention. At the top level 400, user 110 interacts with WCD 100. The interaction involves user 110 entering information via user input 360 and receiving information from user output 370 in order to activate functionality in application level 410. In the application level, programs related to specific functionality within the device interact with both the user and the system level. These programs include applications for visual information (e.g., web browser, DVB-H receiver, etc.), audio information (e.g., cellular telephone, voice mail, conferencing software, DAB or analog radio receiver, etc.), recording information (e.g., digital photography software, word processing, scheduling, etc.) or other information processing. Actions initiated at application level 410 may require information to be sent from or received into WCD 100. In the example of FIG. 4A, data is requested to be sent to a recipient device via Bluetooth™ communication. As a result, application level 410 may then call resources in the system level to initiate the required processing and routing of data.

System level 420 processes data requests and routes the data for transmission. Processing may include, for example, calculation, translation, conversion and/or packetizing the data. The information may then be routed to an appropriate communication resource in the service level. If the desired communication resource is active and available in the service level 430, the packets may be routed to a radio modem for delivery via wireless transmission. There may be a plurality of modems operating using different wireless mediums. For example, in FIG. 4A, modem 4 is activated and able to send packets using Bluetooth™ communication. However, a radio modem (as a hardware resource) need not be dedicated only to a specific wireless medium, and may be used for different types of communication depending on the requirements of the wireless medium and the hardware characteristics of the radio modem.

FIG. 4B discloses a situation wherein the above described exemplary operational process may cause more than one radio modem to become active. In this case, WCD 100 is both transmitting and receiving information via wireless communication over a multitude of mediums. WCD 100 may be interacting with various secondary devices such as those grouped at 480. For example, these devices may include cellular handsets communicating via long-range wireless communication like GSM, wireless headsets communicating via Bluetooth™, Internet access points communicating via WLAN, etc.

Problems may occur when some or all of these communications are carried on simultaneously. As further shown in FIG. 4B, multiple modems operating simultaneously may cause interference for each other. Such a situation may be encountered when WCD 100 is communicating with more than one external device (as previously described). In an exemplary extreme case, devices with modems simultaneously communicating via Bluetooth™, WLAN and wireless USB would encounter substantial overlap since all of these wireless mediums operate in the 2.4 GHz band. The interference, shown as an overlapping portion of the fields depicted in FIG. 4B, would cause packets to be lost and the need for retransmission of these lost packets. Retransmission requires that future time slots be used to retransmit lost information, and therefore, overall communication performance will at least be reduced, if the signal is not lost completely. The present invention, in at least one embodiment, seeks to manage problematic situations where possibly conflicting communications may be occurring simultaneously so that interference is minimized or totally avoided, and as a result, speed and quality are maximized.

### IV. Radio Modem Signal Control in a Wireless Communication Device.

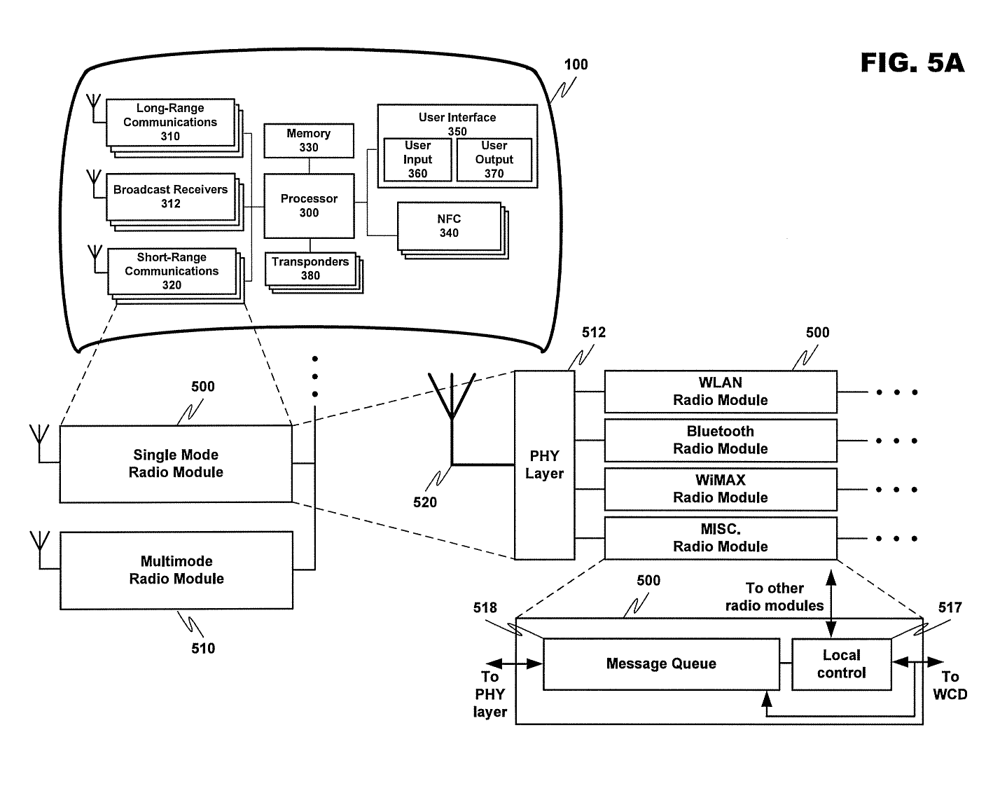

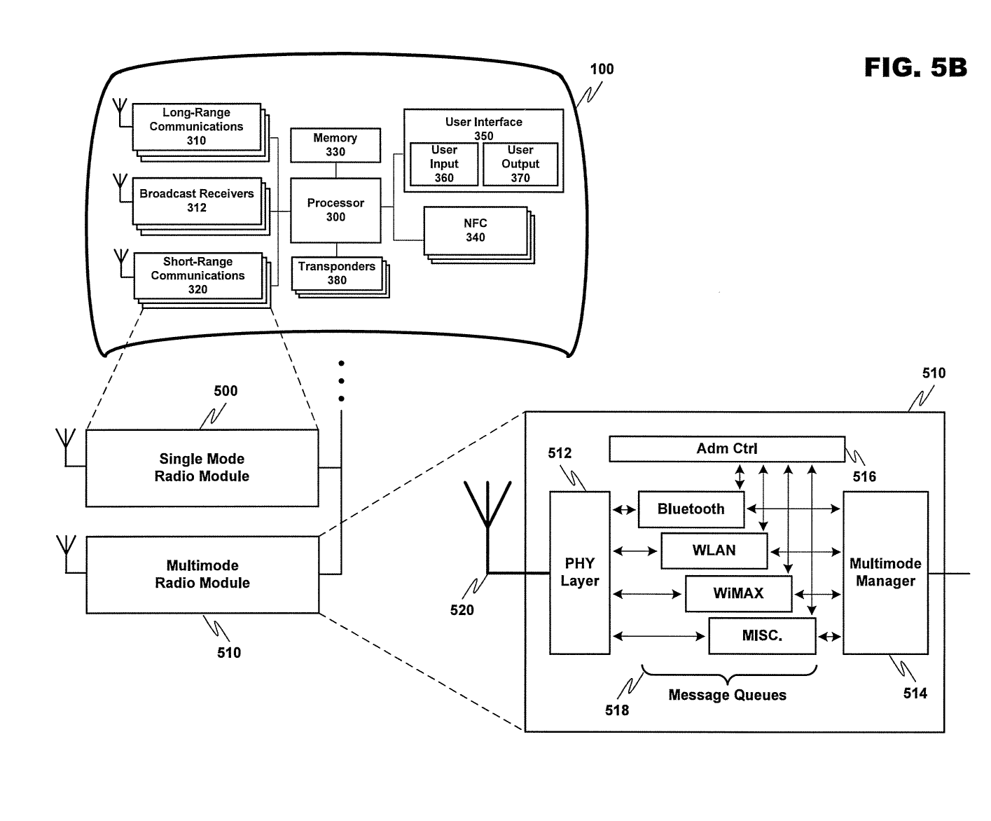

FIG. 5A discloses an example of different types of radio modules that may be implemented in WCD 100. The choice of radio modules to utilize may depend on various requirements for functionality in WCD 100, or conversely, on limitations in the device such as space or power limitations. Radio module 500 is a single mode radio module and radio module 510 is a multimode radio module (explained further in FIG. 5B). Single mode radio module 500 may only support one wireless communication medium at a time (e.g., a single mode radio module may be configured to support Bluetooth™) and may share physical resources (e.g. physical layer 512) such as a common antenna 520 or an antenna array and associated hardware.

Since all of the single mode radio modules may share the resource of physical layer 512 as depicted in FIG. 5A, some sort of control must exist in order to control how each single mode radio module 500 uses these resources. Local controller 517 may therefore be included in each radio modem to control the usage of PHY layer 512. This local controller may take as inputs message information from other components within WCD 100 wishing to send messages via single mode radio module 500 and also information from other single mode radio modules 500 as to their current state. This current state information may include a priority level, an active/inactive state, a number of messages pending, a duration of active communication, etc. Local controller 517 may use this information to control the release of messages from message queue 518 to PHY layer 512, or further, to control the quality level of the messages sent from message queue 518 in order to conserve resources for other wireless communication mediums. The local control in each single mode radio module 500 may take the form of, for example, a schedule for utilization of a wireless communication medium implemented in the radio module.

An exemplary multimode radio module 510 is now explained in FIG. 5B. Multimode radio module 510 may include local control resources for managing each “radio” (e.g., software based radio control stacks) attempting to use the physical layer (PHY) resources of multimode radio module 510. In this example, multimode radio module 510 includes at least three radio stacks or radio protocols (labeled Bluetooth, WLAN and WiMAX in FIG. 5B) that may share the PHY layer resources (e.g., hardware resources, antenna, etc.) of multimode radio module 510. The local control resources may include an admission controller (Adm Ctrl 516) and a multimode controller (Multimode Manager 514). These local control resources may be embodied as a software program and/or in a hardware form (e.g., logic device, gate array, MCM, ASIC, etc.) in a radio modem interface, and the radio modem interface may be coupled to, or alternatively, embedded in multimode radio module 510.

Admission control 516 may act as a gateway for the multimode radio module 510 by filtering out both different wireless communication medium requests from the operating system of WCD 100 that may be sent by multimode radio module 510 and that may further result in conflicts for multimode radio module 510. The conflict information may be sent along with operational schedule information for other radio modules to multimode manager 514 for further processing. The information received by multimode manager 514 may then be used to formulate a schedule, such as a schedule for utilization of wireless communication mediums, controlling the release of messages for transmission from the various message queues 518.

### V. A Wireless Communication Device Including a Multiradio Controller.

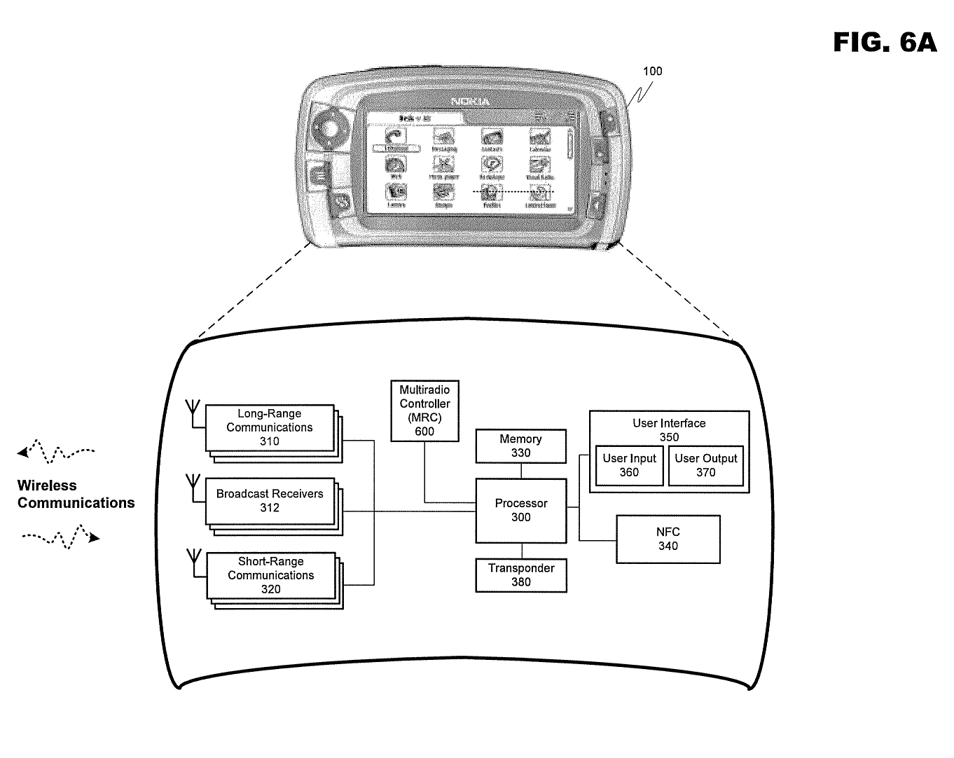

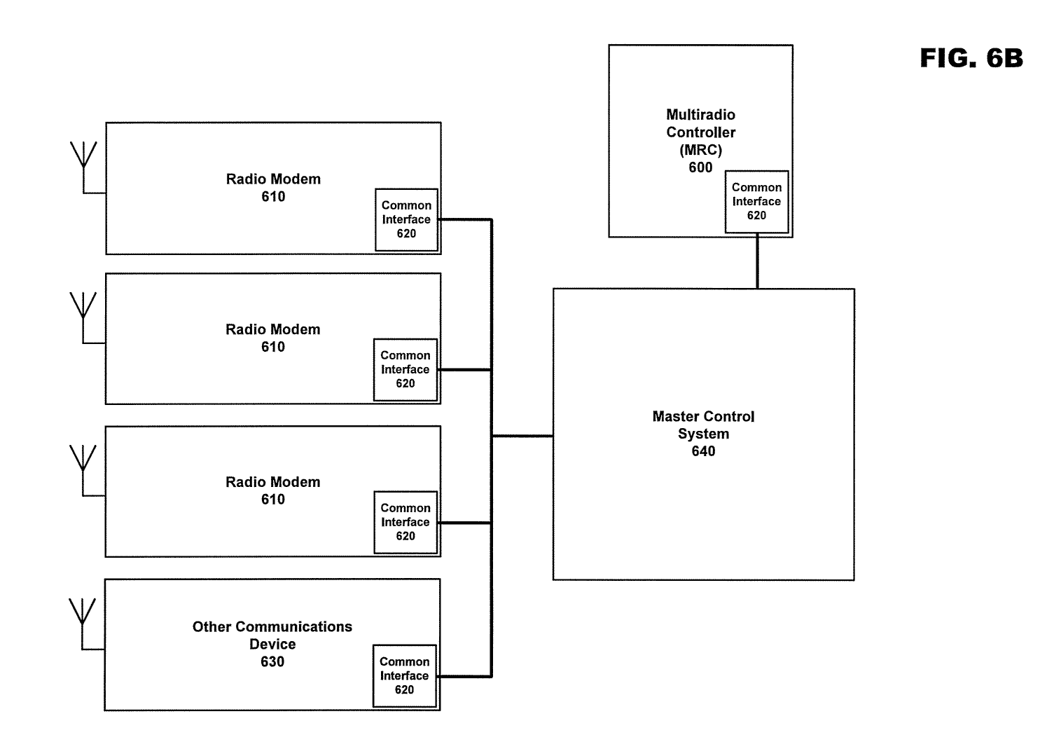

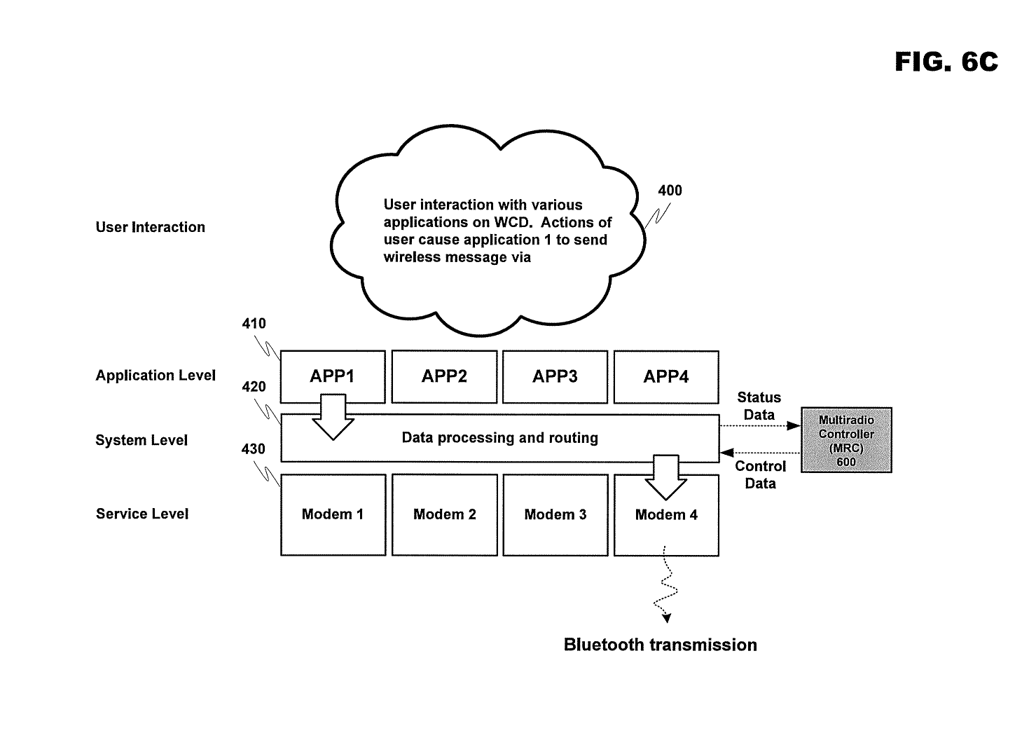

In an attempt to better manage communication in WCD 100, an additional controller dedicated to managing wireless communication may be introduced. WCD 100, as pictured in FIG. 6A, includes a multiradio controller (MRC) 600 in accordance with at least one embodiment of the present invention. MRC 600 is coupled to the master control system of WCD 100. This coupling enables MRC 600 to communicate with radio modems or other similar devices in communications modules 310 312, 320 and 340 via the master operating system of WCD 100.

FIG. 6B discloses in detail at least one embodiment of WCD 100, which may include multiradio controller (MRC) 600 introduced in FIG. 6A in accordance with at least one embodiment of the present invention. MRC 600 includes common interface 620 by which information may be sent or received through master control system 640. Radio modems 610 and other devices 630 may also be referred to as “modules” in this disclosure as they may contain supporting hardware and/or software resources in addition to the modem itself. These resources may include control, interface and/or processing resources. For example, each radio modem 610 or similar communication device 630 (e.g., an RFID scanner for scanning machine-readable information) may also include some sort of common interface 620 for communicating with master control system 640. As a result, all information, commands, etc. occurring between radio modems 610, similar devices 630 and MRC 600 are conveyed by the communication resources of master control system 640. The possible effect of sharing communication resources with all the other functional modules within WCD 100 will be discussed with respect to FIG. 6C.

FIG. 6C discloses an operational diagram similar to FIG. 4 including the effect of MRC 600 in accordance with at least one embodiment of the present invention. In this system MRC 600 may receive operational data from the master operating system of WCD 100, concerning for example applications running in application level 410, and status data from the various radio communication devices in service level 430. MRC 600 may use this information to issue scheduling commands to the communication devices in service level 430 in an attempt to avoid communication problems. However, problems may occur when the operations of WCD 100 are fully employed. Since the various applications in application level 410, the operating system in system level 420, the communication devices in service level 430 and MRC 600 must all share the same communication system, delays may occur when all aspects of WCD 100 are trying to communicate on the common interface system 620. As a result, delay sensitive information regarding both communication resource status information and radio modem 610 control information may become delayed, nullifying any beneficial effect from MRC 600. Therefore, a system better able to handle the differentiation and routing of delay sensitive information is required if the beneficial effect of MRC 600 is to be realized.

### VI. A Wireless Communication Device Including a Multiradio Control System.

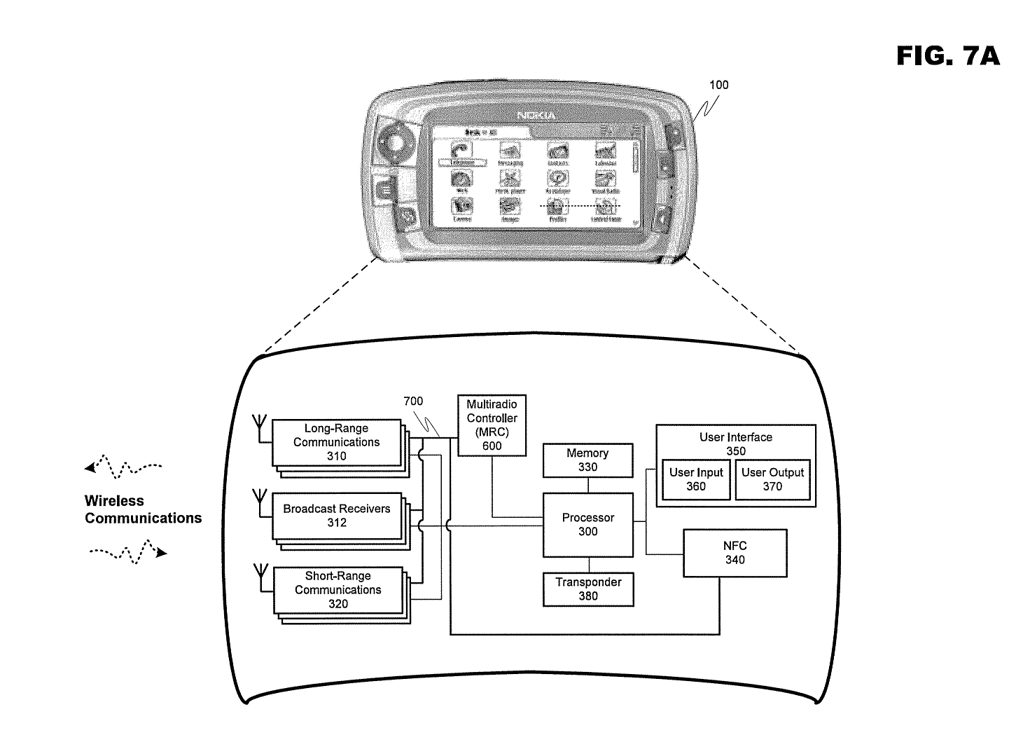

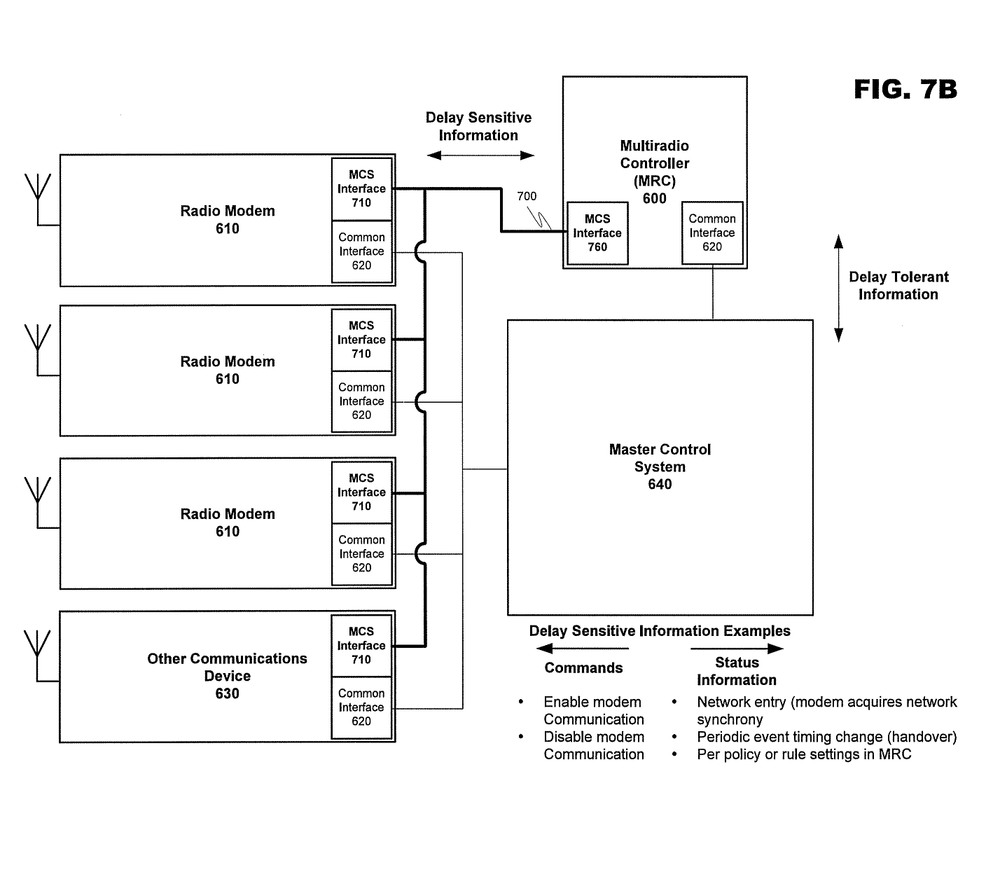

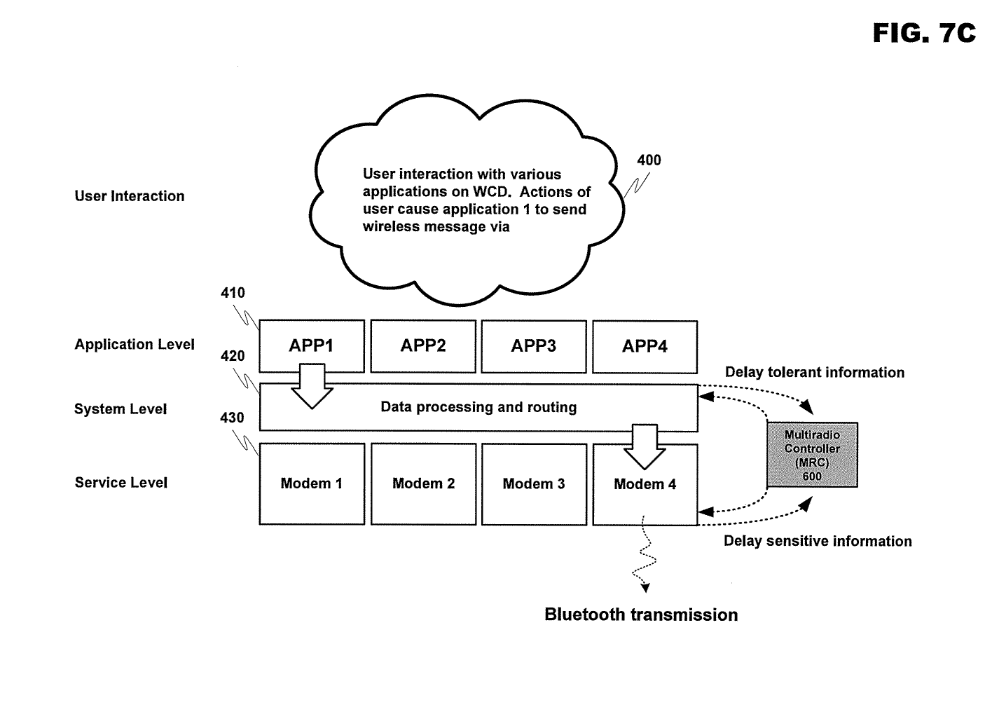

FIG. 7A introduces MRC 600 as part of a multiradio control system (MCS) 700 in WCD 100 in accordance with at least one embodiment of the present invention. MCS 700 directly links the communication resources of modules 310, 312, 320 and 340 to MRC 600. MCS 700 may provide a dedicated low-traffic communication structure for carrying delay sensitive information both to and from MRC 600.

Additional detail is shown in FIG. 7B. MCS 700 forms a direct link between MRC 600 and the communication resources of WCD 100. This link may be established by a system of dedicated MCS interfaces 710 and 760. For example, MCS interface 760 may be coupled to MRC 600. MCS Interfaces 710 may connect radio modems 610 and other similar communication devices 630 to MCS 700 in order to form an information conveyance for allowing delay sensitive information to travel to and from MRC 600. In this way, the abilities of MRC 600 are no longer influenced by the processing load of master control system 640. As a result, any information still communicated by master control system 640 to and from MRC 600 may be deemed delay tolerant, and therefore, the actual arrival time of this information does not substantially influence system performance. On the other hand, all delay sensitive information is directed to MCS 700, and therefore is insulated from the loading of the master control system.

The effect of MCS 700 is seen in FIG. 7C in accordance with at least one embodiment of the present invention. Information may now be received in MRC 600 from at least two sources. System level 420 may continue to provide information to MRC 600 through master control system 640. In addition, service level 430 may specifically provide delay sensitive information conveyed by MCS 700. MRC 600 may distinguish between these two classes of information and act accordingly. Delay tolerant information may include information that typically does not change when a radio modem is actively engaged in communication, such as radio mode information (e.g., GPRS, Bluetooth™, WLAN, etc.), priority information that may be defined by user settings, the specific service the radio is driving (QoS, real time/non real time), etc. Since delay tolerant information changes infrequently, it may be delivered in due course by master control system 640 of WCD 100. Alternatively, delay sensitive (or time sensitive) information includes at least modem operational information that frequently changes during the course of a wireless connection, and therefore, requires immediate update. As a result, delay sensitive information may need to be delivered directly from the plurality of radio modems 610 through the MCS interfaces 710 and 760 to MRC 600, and may include radio modem synchronization information. Delay sensitive information may be provided in response to a request by MRC 600, or may be delivered as a result of a change in radio modem settings during transmission, as will be discussed with respect to synchronization below.

### VIII. A Wireless Communication Device Including a Distributed Multiradio Control System.

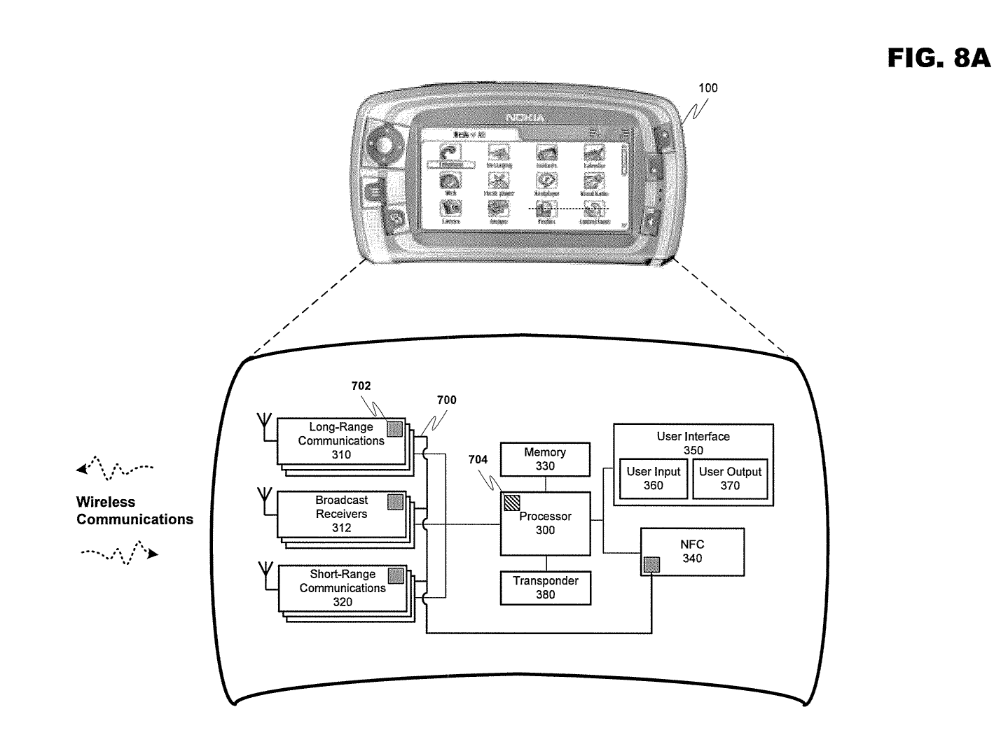

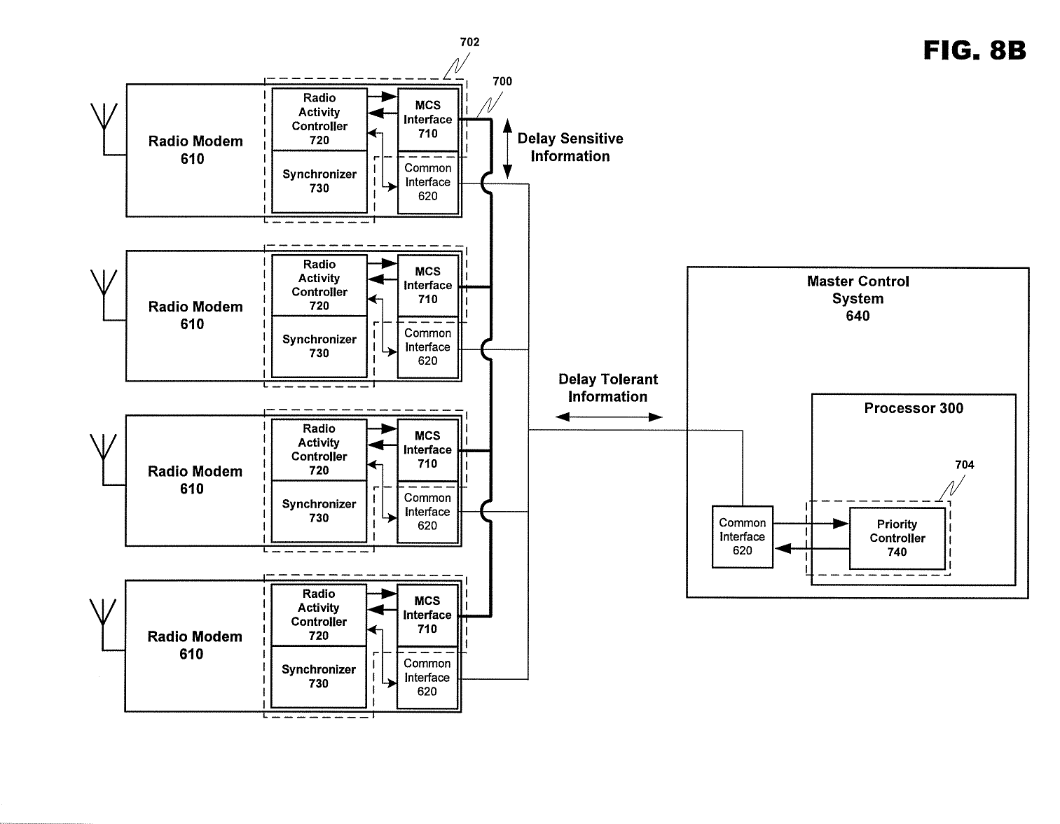

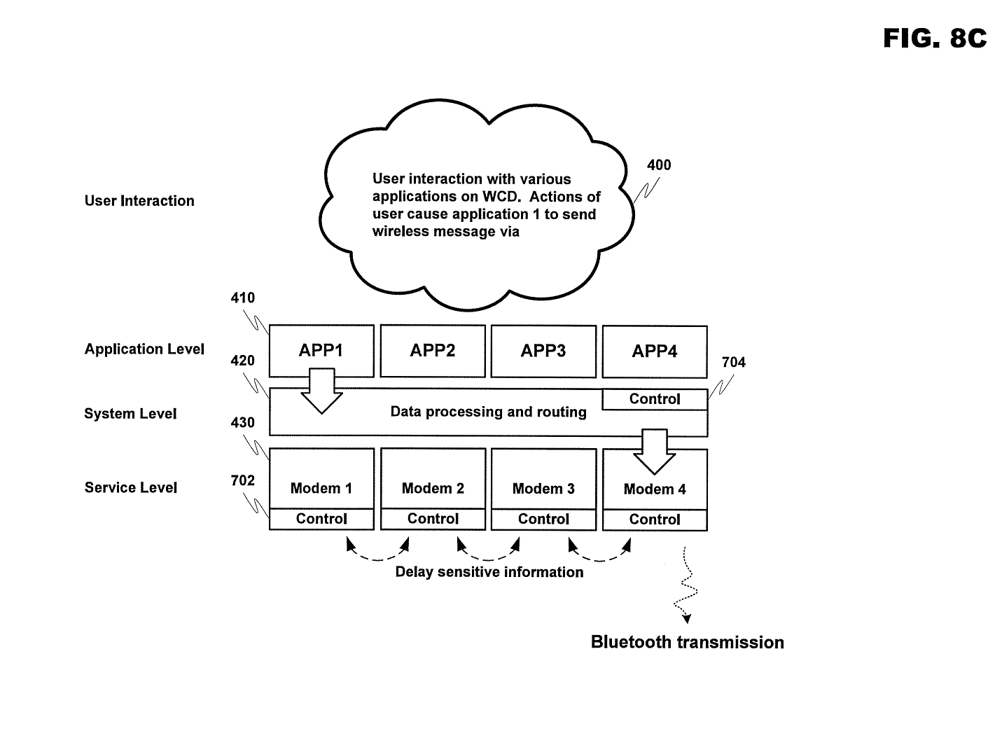

FIG. 8A discloses an alternative configuration in accordance with at least one embodiment of the present invention, wherein a distributed multiradio control system (MCS) 700 is introduced into WCD 100. Distributed MCS 700 may, in some cases, be deemed to provide an advantage over a centralized MRC 600 by distributing these control features into already necessary components within WCD 100. As a result, a substantial amount of the communication management operations may be localized to the various communication resources, such as radio modems (modules) 610, reducing the overall amount of control command traffic in WCD 100.

MCS 700, in this example, may be implemented utilizing a variety of bus structures, including the I²C interface commonly found in portable electronic devices, as well as emerging standards such as SLIMbus that are now under development. I²C is a multi-master bus, wherein multiple devices can be connected to the same bus and each one can act as a master through initiating a data transfer. An I²C bus contains at least two communication lines, an information line and a clock line. When a device has information to transmit, it assumes a master role and transmits both its clock signal and information to a recipient device. SLIMbus, on the other hand, utilizes a separate, non-differential physical layer that runs at rates of 50 Mbits/s or slower over just one lane. It is being developed by the Mobile Industry Processor Interface (MIPI) Alliance to replace today's I²C and I²S interfaces while offering more features and requiring the same or less power than the two combined.

MCS 700 directly links distributed control components 702 in modules 310, 312, 320 and 340. Another distributed control component 704 may reside in master control system 640 of WCD 100. It is important to note that distributed control component 704 shown in processor 300 is not limited only to this embodiment, and may reside in any appropriate system module within WCD 100. The addition of MCS 700 provides a dedicated low-traffic communication structure for carrying delay sensitive information both to and from the various distributed control components 702.

The exemplary embodiment disclosed in FIG. 8A is described with more detail in FIG. 8B. MCS 700 forms a direct link between distributed control components 702 within WCD 100. Distributed control components 702 in radio modems 610 (together forming a “module”) may, for example, consist of MCS interface 710, radio activity controller 720 and synchronizer 730. Radio activity controller 720 uses MCS interface 710 to communicate with distributed control components in other radio modems 610. Synchronizer 730 may be utilized to obtain timing information from radio modem 610 to satisfy synchronization requests from any of the distributed control components 702. Radio activity controller 702 may also obtain information from master control system 640 (e.g., from distributed control component 704) through common interface 620. As a result, any information communicated by master control system 640 to radio activity controller 720 through common interface 620 may be deemed delay tolerant, and therefore, the actual arrival time of this information does not substantially influence communication system performance. On the other hand, all delay sensitive information may be conveyed by MCS 700, and therefore is insulated from master control system overloading.

As previously stated, a distributed control component 704 may exist within master control system 640. Some aspects of this component may reside in processor 300 as, for example, a running software routine that monitors and coordinates the behavior of radio activity controllers 720. Processor 300 is shown to contain priority controller 740. Priority controller 740 may be utilized to monitor active radio modems 610 in order to determine priority amongst these devices. Priority may be determined by rules and/or conditions stored in priority controller 740. Modems that become active may request priority information from priority controller 740. Further, modems that go inactive may notify priority controller 740 so that the relative priority of the remaining active radio modems 610 may be adjusted accordingly. Priority information is usually not considered delay sensitive because it is mainly updated when radio modems 610 activate/deactivate, and therefore, does not frequently change during the course of an active communication connection in radio modems 610. As a result, this information may be conveyed to radio modems 610 using common interface system 620 in at least one embodiment of the present invention.

At least one effect of a distributed control MCS 700 is seen in FIG. 8C. System level 420 may continue to provide delay tolerant information to distributed control components 702 through master control system 640. In addition, distributed control components 702 in service level 430, such as modem activity controllers 720, may exchange delay sensitive information with each other via MCS 700. Each distributed control component 702 may distinguish between these two classes of information and act accordingly. Delay tolerant information may include information that typically does not change when a radio modem is actively engaged in communication, such as radio mode information (e.g., GPRS, Bluetooth™, WLAN, etc.), priority information that may be defined by user settings, the specific service the radio is driving (QoS, real time/non real time), etc. Since delay tolerant information changes infrequently, it may be delivered in due course by master control system 640 of WCD 100. Alternatively, delay sensitive (or time sensitive) information may include at least modem operational information that frequently changes during the course of a wireless connection, and therefore, requires immediate update. Delay sensitive information needs to be delivered directly between distributed control components 702, and may include radio modem synchronization and activity control information. Delay sensitive information may be provided in response to a request, or may be delivered as a result of a change in radio modem, which will be discussed with respect to synchronization below.

MCS interface 710 may be used to (1) Exchange synchronization information, and (2) Transmit identification or prioritization information between various radio activity controllers 720. In addition, as previously stated, MCS interface 710 is used to communicate the radio parameters that are delay sensitive from a controlling point of view. MCS interface 710 can be shared between different radio modems (multipoint) but it cannot be shared with any other functionality that could limit the usage of MCS interface 710 from a latency point of view.

The control signals sent on MCS 700 that may enable/disable a radio modem 610 should be built on a modem's periodic events. Each radio activity controller 720 may obtain this information about a radio modem's periodic events from synchronizer 730. This kind of event can be, for example, frame clock event in GSM (4.615 ms), slot clock event in Bluetooth™ (625 us) or targeted beacon transmission time in WLAN (100 ms) or any multiple of these. A radio modem 610 may send its synchronization indications when (1) Any radio activity controller 720 requests it, (2) a radio modem internal time reference is changed (e.g. due to handover or handoff). The latency requirement for the synchronization signal is not critical as long as the delay is constant within a few microseconds. The fixed delays can be taken into account in the scheduling logic of radio activity controller 710.

For predictive wireless communication mediums, the radio modem activity control may be based on the knowledge of when the active radio modems 610 are about to transmit (or receive) in the specific connection mode in which the radios are currently operating. The connection mode of each radio modem 610 may be mapped to the time domain operation in their respective radio activity controller 720. As an example, for a GSM speech connection, priority controller 740 may have knowledge about all traffic patterns of GSM. This information may be transferred to the appropriate radio activity controller 720 when radio modem 610 becomes active, which may then recognize that the speech connection in GSM includes one transmission slot of length 577 μs, followed by an empty slot after which is the reception slot of 577 μs, two empty slots, monitoring (RX on), two empty slots, and then it repeats. Dual transfer mode means two transmission slots, empty slot, reception slot, empty slot, monitoring and two empty slots. When all traffic patterns that are known a priori by the radio activity controller 720, it only needs to know when the transmission slot occurs in time to gain knowledge of when the GSM radio modem is active. This information may be obtained by synchronizer 730. When the active radio modem 610 is about to transmit (or receive) it must check every time whether the modem activity control signal from its respective radio activity controller 720 permits the communication. Radio activity controller 720 is always either allowing or disabling the transmission of one full radio transmission block (e.g. GSM slot).

### IX. A Wireless Communication Device Including an Alternative Example of a Distributed Multiradio Control System.

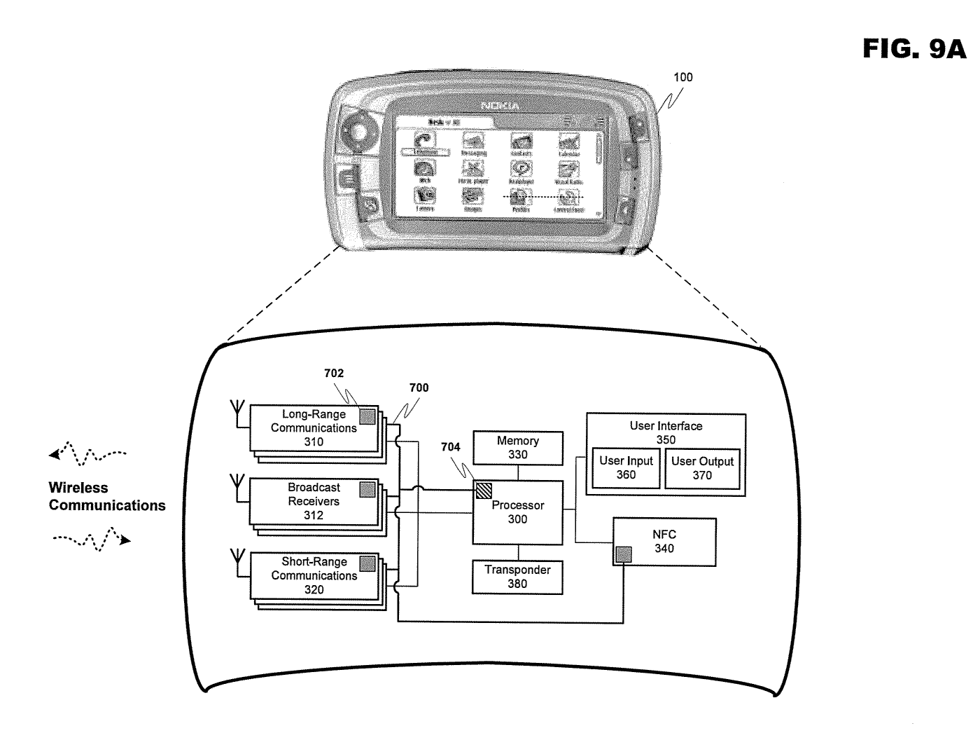

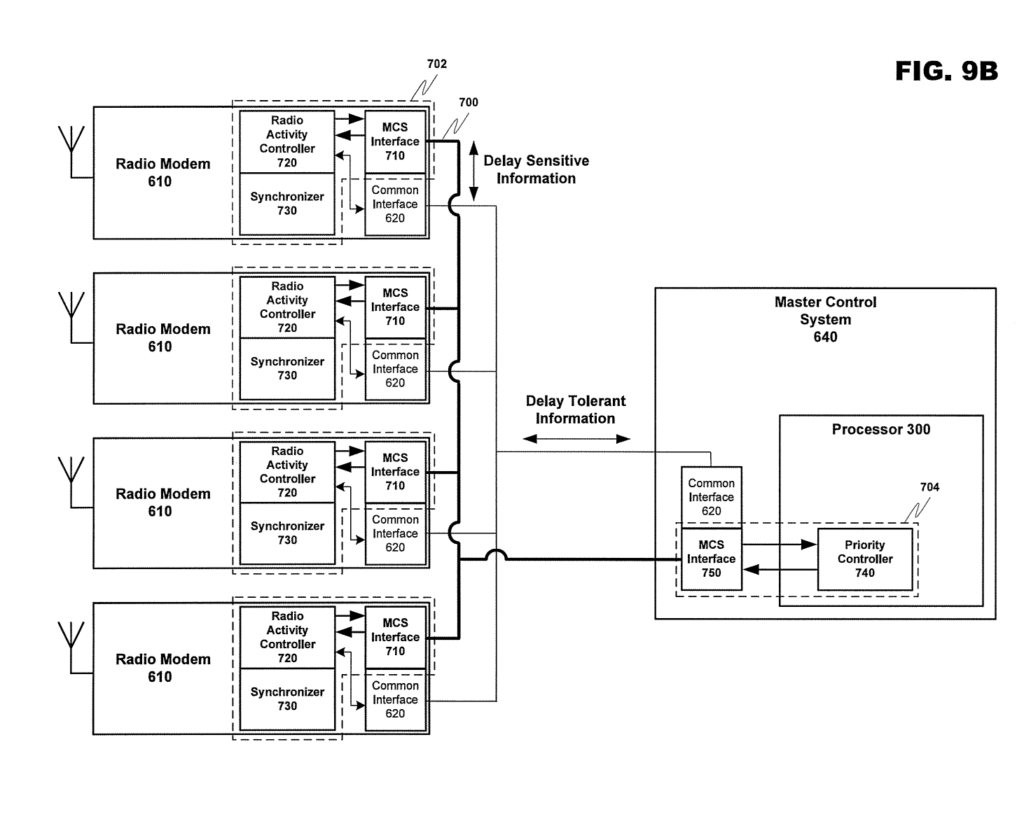

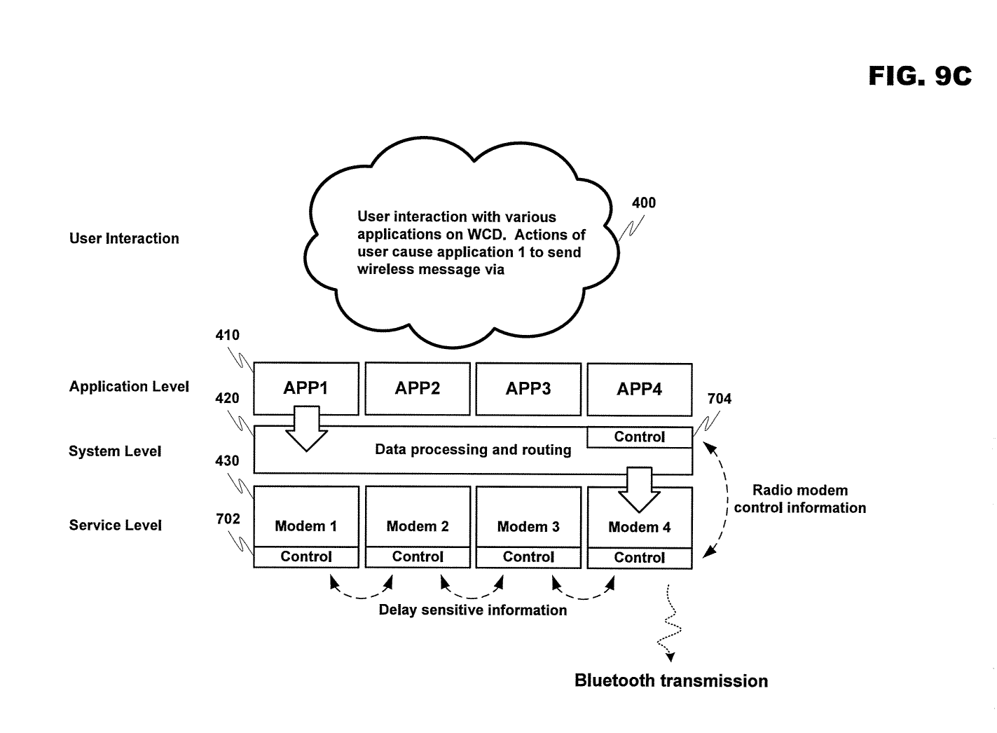

An alternative distributed control configuration in accordance with at least one embodiment of the present invention is disclosed in FIG. 9A-9C. In FIG. 9A, distributed control components 702 continue to be linked by MCS 700. However, now distributed control component 704 is also directly coupled to distributed control components 702 via an MCS interface. As a result, distributed control component 704 may also utilize and benefit from MCS 700 for transactions involving the various communication components of WCD 100.

Referring now to FIG. 9B, the inclusion of distributed control component 704 onto MCS 700 is shown in more detail. Distributed control component 704 includes at least priority controller 740 coupled to MCS interface 750. MCS interface 750 allows priority controller 740 to send information to, and receive information from, radio activity controllers 720 via a low-traffic connection dedicated to the coordination of communication resources in WCD 100. As previously stated, the information provided by priority controller 740 may not be deemed delay sensitive information, however, the provision of priority information to radio activity controllers 720 via MCS 700 may improve the overall communication efficiency of WCD 100. Performance may improve because quicker communication between distributed control components 702 and 704 may result in faster relative priority resolution in radio activity controllers 720. Further, the common interface system 620 of WCD 100 will be relieved of having to accommodate communication traffic from distributed control component 704, reducing the overall communication load in master control system 640. Another benefit may be realized in communication control flexibility in WCD 100. New features may be introduced into priority controller 740 without worrying about whether the messaging between control components will be delay tolerant or sensitive because an MCS interface 710 is already available at this location.

FIG. 9C discloses the operational effect of the enhancements seen in the current alternative embodiment of the present invention on communication in WCD 100. The addition of an alternative route for radio modem control information to flow between distributed control components 702 and 704 may both improve the communication management of radio activity controllers 720 and lessen the burden on master control system 640. In this embodiment, all distributed control components of MCS 700 are linked by a dedicated control interface, which provides immunity to communication coordination control messaging in WCD 100 when the master control system 640 is experiencing elevated transactional demands.

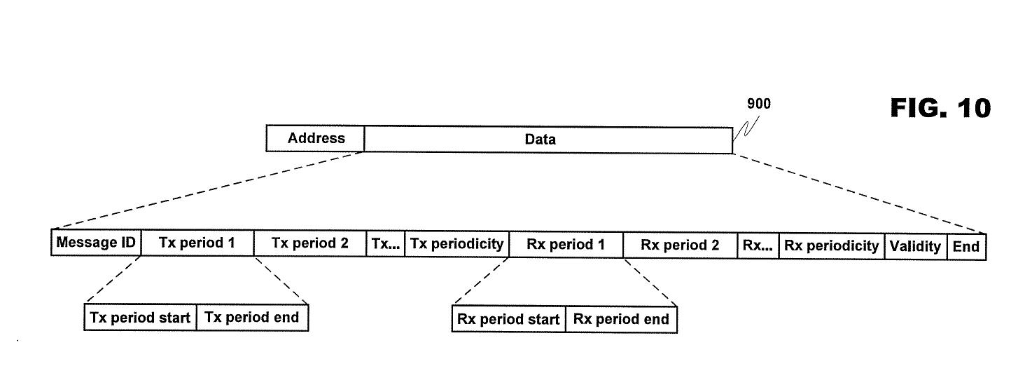

An example message packet 900 is disclosed in FIG. 10 in accordance with at least one embodiment of the present invention. Example message packet 900 includes activity pattern information that may be formulated by MRC 600 or radio activity controller 720. The data payload of packet 900 may include, in at least one embodiment of the present invention, at least Message ID information, allowed/disallowed transmission (Tx) period information, allowed/disallowed reception (Rx) period information, Tx/Rx periodicity (how often the Tx/Rx activities contained in the period information occur), and validity information describing when the activity pattern becomes valid and whether the new activity pattern is replacing or added to the existing one. The data payload of packet 900, as shown, may consist of multiple allowed/disallowed periods for transmission or reception (e.g., Tx period 1, 2 . . . ) each containing at least a period start time and a period end time during which radio modem 610 may either be permitted or prevented from executing a communication activity. While the distributed example of MCS 700 may allow radio modem control activity to be controlled real-time (e.g., more control messages with finer granularity), the ability to include multiple allowed/disallowed periods into a single message packet 900 may support radio activity controllers 720 in scheduling radio modem behavior for longer periods of time, which may result in a reduction in message traffic. Further, changes in radio modem 610 activity patterns may be amended using the validity information in each message packet 900.

The modem activity control signal (e.g., packet 900) may be formulated by MRC 600 or radio activity controller 720 and transmitted on MCS 700. The signal includes activity periods for Tx and Rx separately, and the periodicity of the activity for the radio modem 610. While the native radio modem clock is the controlling time domain (never overwritten), the time reference utilized in synchronizing the activity periods to current radio modem operation may be based on one of at least two standards. In a first example, a transmission period may start after a pre-defined amount of synchronization events have occurred in radio modem 610. Alternatively, all timing for MRC 600 or between distributed control components 702 may be standardized around the system clock for WCD 100. Advantages and disadvantages exist for both solutions. Using a defined number of modem synchronization events is beneficial because then all timing is closely aligned with the radio modem clock. However, this strategy may be more complicated to implement than basing timing on the system clock. On the other hand, while timing based on the system clock may be easier to implement as a standard, conversion to modem clock timing must necessarily be implemented whenever a new activity pattern is installed in radio modem 610.

The activity period may be indicated as start and stop times. If there is only one active connection, or if there is no need to schedule the active connections, the modem activity control signal may be set always on allowing the radio modems to operate without restriction. The radio modem 610 should check whether the transmission or reception is allowed before attempting actual communication. The activity end time can be used to check the synchronization. Once the radio modem 610 has ended the transaction (slot/packet/burst), it can check whether the activity signal is still set (it should be due to margins). If this is not the case, the radio modem 610 can initiate a new synchronization with MRC 600 or with radio activity controller 720 through synchronizer 730. The same happens if a radio modem time reference or connection mode changes. A problem may occur if radio activity controller 720 runs out of the modem synchronization and starts to apply modem transmission/reception restrictions at the wrong time. Due to this, modem synchronization signals need to be updated periodically. The more active wireless connections, the more accuracy is required in synchronization information.

### X. Radio Modem Interface to Other Devices.

As a part of information acquisition services, the MCS interface 710 needs to send information to MRC 600 (or radio activity controllers 720) about periodic events of the radio modems 610. Using its MCS interface 710, the radio modem 610 may indicate a time instance of a periodic event related to its operation. In practice these instances are times when radio modem 610 is active and may be preparing to communicate or communicating. Events occurring prior to or during a transmission or reception mode may be used as a time reference (e.g., in case of GSM, the frame edge may be indicated in a modem that is not necessarily transmitting or receiving at that moment, but we know based on the frame clock that the modem is going to transmit [x]ms after the frame clock edge). Basic principle for such timing indications is that the event is periodic in nature. Every incident needs not to be indicated, but the MRC 600 may calculate intermediate incidents itself. In order for that to be possible, the controller would also require other relevant information about the event, e.g. periodicity and duration. This information may be either embedded in the indication or the controller may get it by other means. Most importantly, these timing indications need to be such that the controller can acquire a radio modem's basic periodicity and timing. The timing of an event may either be in the indication itself, or it may be implicitly defined from the indication information by MRC 600 (or radio activity controller 720).

In general terms these timing indications need to be provided on periodic events like: schedule broadcasts from a base station (typically TDMA/MAC frame boundaries) and own periodic transmission or reception periods (typically Tx/Rx slots). Those notifications need to be issued by the radio modem 610: (1) on network entry (i.e. modem acquires network synchrony), (2) on periodic event timing change e.g. due to a handoff or handover and (3) as per the policy and configuration settings in the multiradio controller (monolithic or distributed). In at least one embodiment of the present invention, the various messages exchanged between the aforementioned communication components in WCD 100 may be used to dictate behavior on both a local (radio modem level) and global (WCD level) basis. MRC 600 or radio activity controller 720 may deliver a schedule to radio modem 610 with the intent of controlling that specific modem, however, radio modem 610 may not be compelled to conform to this schedule. The basic principle is that radio modem 610 is not only operating according to multiradio control information (e.g., operates only when MRC 600 allows) but is also performing internal scheduling and link adaptation while taking MRC scheduling information into account.

### XI. Control of a Wireless Communication Medium Operating in a Continuous Mode.

Initially, it is important to note that while Bluetooth™ and WLAN are discussed in the following examples, these wireless communication mediums are used only for the sake of explanation in the present disclosure. The present invention may be applicable for managing any wireless communication medium that includes a substantially continuous mode of operation, wherein operations in this continuous mode may conflict with other wireless communication.

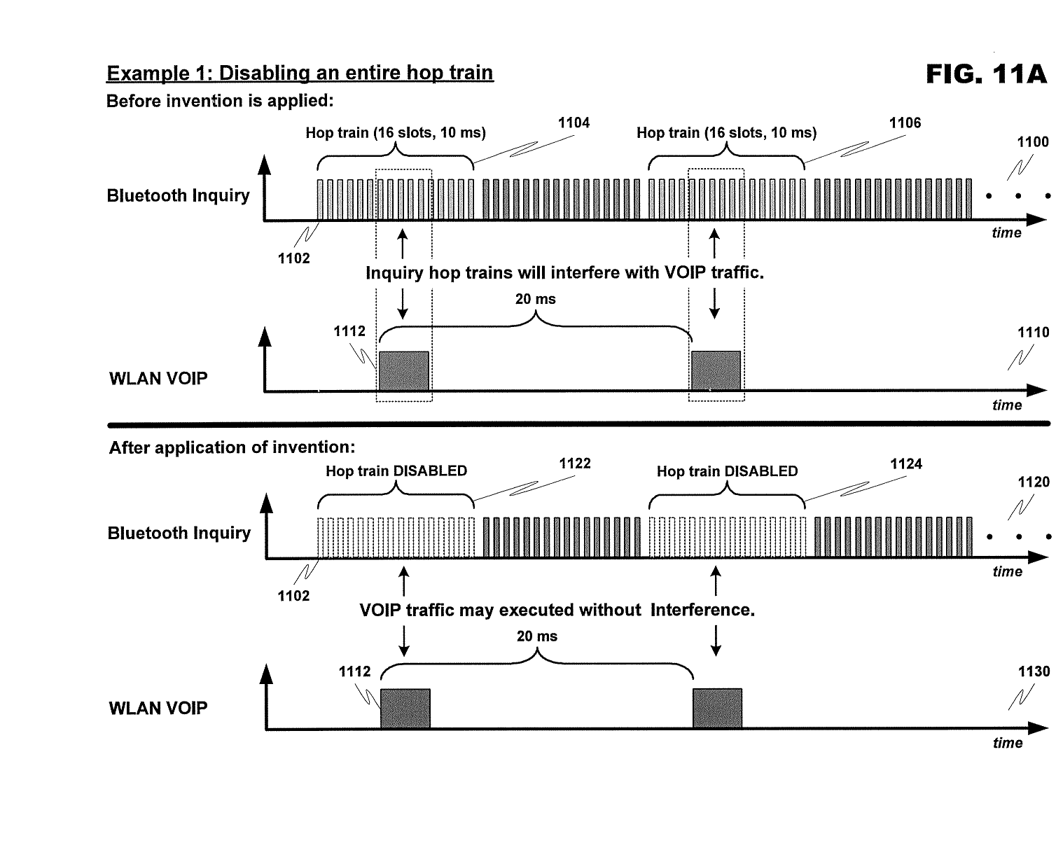

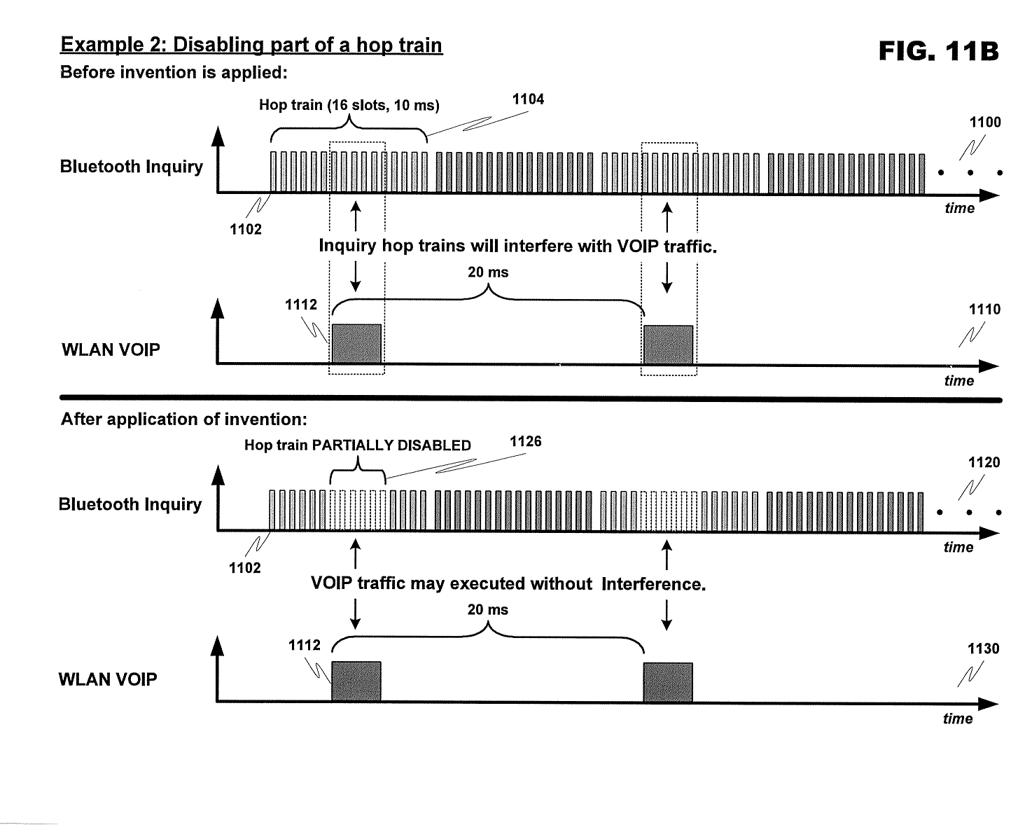

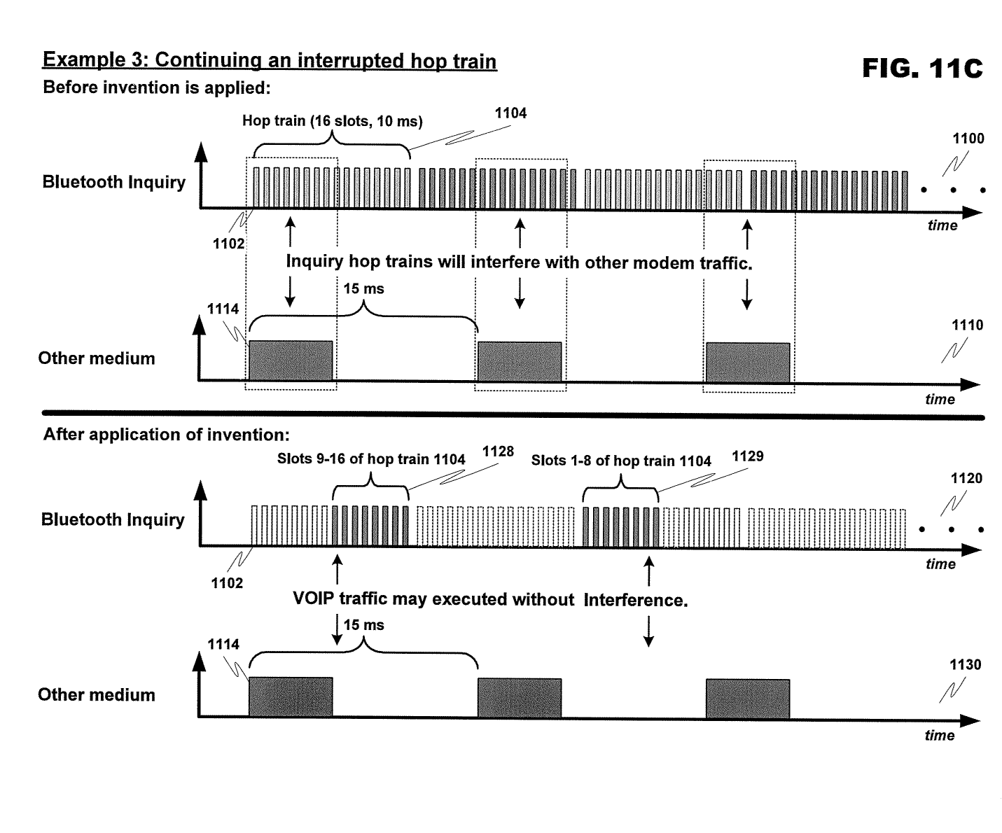

In accordance with at least one embodiment of the present invention, FIG. 11A discloses an example of one way in which communication may be altered in WCD 100 in order to remedy the communication conflict situations. An exemplary Bluetooth™ inquiry and WLAN voice over internet protocol (VoIP) stream are shown at 1100 and 1110, respectively. In this example, Bluetooth™ inquiry 1100 may be executed in accordance with the inquiry sub state defined in section 8.4.2 of the Bluetooth™ specification. This section of the Bluetooth™ specification explains that the TX and RX frequencies shall follow the inquiry hopping sequence and the inquiry response hopping sequence, and are determined by the general inquiry access code and the native clock of the discovering device. In between inquiry transmissions, the receiver shall scan for inquiry response messages. When a response is received, the entire packet (an FHS packet) is read, after which the device shall continue with inquiry transmissions. The device in an inquiry substate shall not acknowledge the inquiry response messages. If enabled by the Host (see HCI [Part E] Section 7.3.54), the RSSI value of the inquiry response message shall be measured. It shall keep probing at different hop channels and in between listening for response packets. As in the page substate, two 10 ms trains A and B are defined, splitting the 32 frequencies of the inquiry hopping sequence into two 16-hop parts (e.g., trains). A single train shall be repeated for at least N_{inquiry}=256 times before a new train is used. In order to collect all responses in an error-free environment, at least three train switches must have taken place. As a result, the inquiry substate may have to last for 10.24 s unless the inquirer collects enough responses and aborts the inquiry substate earlier. As set forth above, a total of 32 frequencies may be scanned in two 16-timeslot hop trains 1104 as depicted, for example, in FIG. 11A. For example, a different frequency may be scanned in each timeslot 1102 of a hop train 1104. Hop trains 1104 may be repeated for a variable number of iterations depending on, for example, the number of synchronous active connections present in the inquiring device during the inquiry. As more synchronous connections are established, more inquiry repetitions may then be required.

WLAN VoIP 1110 activity is also disclosed in FIG. 11A. VoIP packets 1112 occur in this example at a 20 ms interval. As depicted by the dotted lines, the continuous nature of Bluetooth™ inquiry 1100 does not provide any free time period during which VoIP may operate, and as a result, an interference situation will occur. This interference may cause one or both wireless communication streams to experience errors impacting the overall communication performance of WCD 100, and in the worst case, may cause a total communication link failure in one or both wireless communication mediums.

Rescheduled Bluetooth™ inquiry 1120 and WLAN VoIP 1130, further depicted on the bottom of FIG. 11A, discloses an exemplary implementation of the present invention that may be utilized in order to avoid communication problems such as discussed above. The present invention, in at least one embodiment, may allow the overall operation of Bluetooth™ inquiry 1100 to continue execution substantially in accordance with the procedure as set forth above, but may also occasionally alter the inquiry execution, such as shown at 1120, to allow other wireless communication mediums some time for operation. In this example, hop trains 1104 and 1106, previously discussed as being problematic due to potential interference with WLAN VoIP 1112, have been totally disabled at 1122 and 1124. Other hop trains not conflicting with other wireless communication mediums are permitted to continue operation in rescheduled Bluetooth inquiry 1120. As a result, the total execution time of rescheduled Bluetooth™ inquiry 1120 may become extended, however, potential communication conflicts between rescheduled Bluetooth™ inquiry 1120 and WLAN VoIP 1112 have been avoided, allowing the mediums operate concurrently.

Now referring to FIG. 11B, an example of selectively canceling conflicting timeslots 1102 is now disclosed. Again, the same communication situation as depicted in 11A is shown at Bluetooth™ inquiry 1100 and WLAN VoIP 1110 in FIG. 11B. However, instead of having to cancel an entire hop train 1104, now the wireless communication medium operating in a substantially continuous mode and/or radio module 610 support canceling individual timeslots 1102. More specifically, only the timeslot transmit/receive (TX/RX) pairs that conflict with VoIP packet 1112 may be cancelled at 1126 (e.g., if the inquiry TX slot is cancelled, no resulting RX would be received). This more-refined control resolution may allow for better optimization of the active wireless communication mediums because only conflicting timeslots are cancelled.

What then happens to the frequency scans that were scheduled to occur during the canceled timeslots 1102 of rescheduled Bluetooth™ inquiry 1120? In at least one embodiment of the present invention, the frequency scan TX/RX pairs scheduled to occur during cancelled timeslots 1102 may be executed at a later time. FIG. 11C discloses an exemplary rescheduling in accordance with this strategy. The activity of another wireless communication medium is shown at 1110. Communication packets 1114 are predicted to interfere with at least one hop train 1104 in Bluetooth™ inquiry 1100. In order to avoid a communication collision, one or more timeslots 1102 (e.g., consisting of TX/RX pairs) in hop train 1104 may be canceled. In accordance with the exemplary rescheduled Bluetooth inquiry 1120 in FIG. 11C, conflicting timeslots 1-8 may be cancelled in hop train 1104. However, the remaining timeslots 1102 of hop train 1104 are not conflicting with the activity of other medium 1130, and therefore, remaining timeslots 9-16 may be permitted to execute as shown at 1128. Later, during a free period 1129 between other medium packets 1114, the TX/RX pairs of timeslots 1-8 in hop train 1104 may be rescheduled to execute. In this way, all of the TX/RX pairs of hop train 1104 may execute in their designated order without conflicting with packets 1114 in other wireless communication medium 1130.

The control strategy implemented in the present invention may be carried out in a variety of configurations. For example, a centralized or distributed MRC 600 may evaluate operational schedules for each active wireless communication medium. The result of this evaluation may include at least a determination as to whether any potential conflicts exist between the operational schedules, and further, if any of the potentially conflicting wireless communication mediums are operating in a substantially continuous mode, for example, operating in a device discovery mode. If the aforementioned conditions are true, MRC 600 may alter the operation of a wireless communication medium operating in a substantially continuous mode in accordance with the previous exemplary strategies to avoid communication conflicts.

Another configuration that may be employed in managing the operation of a wireless communication medium operating in a substantially continuous mode may include adding new information to the BT Host Control Interface (HCI). Currently the HCI specification defines a HCI command to start the inquiry. Inside the command the length of the inquiry is included as a parameter. The configuration of the interrupt period and length could be either added to this command (which would require change to the BT specification) or be defined as a separate vendor specific HCI command.

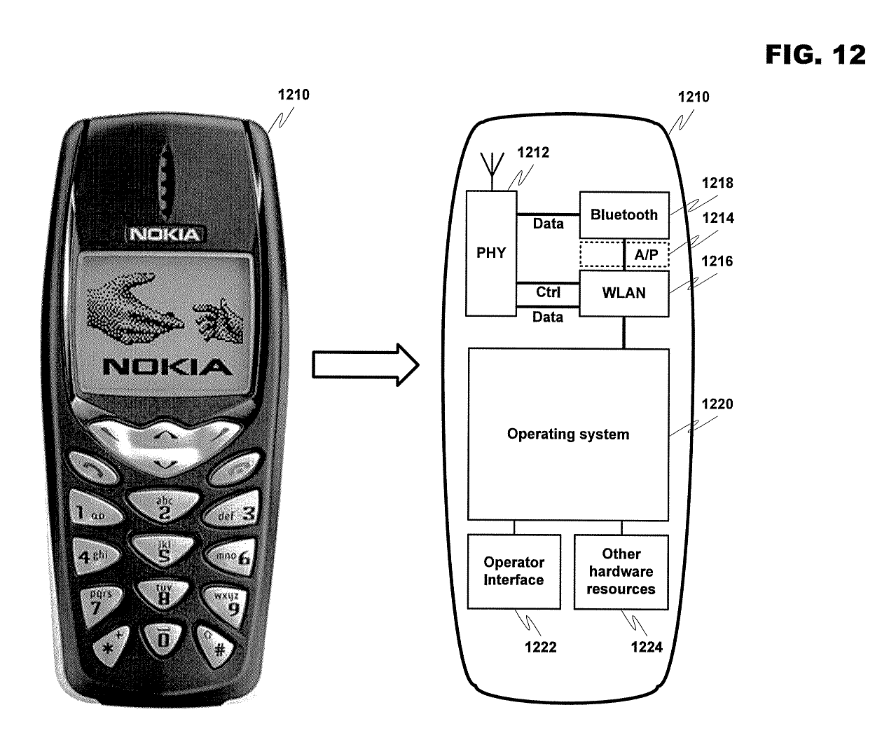

At least one embodiment of the present invention as implemented in a simple device (e.g., a cellular handset) 1210 is disclosed in FIG. 12. This device may utilize a shared physical layer (PHY) 1212 including hardware and/or software for supporting the transmission and reception of wireless packets over at least one antenna. Also in this example, WLAN radio module 1216 and Bluetooth™ radio module 1218 and may be coupled to PHY 1212 through the various access lines utilized for controlling (e.g., “Ctrl”) and/or conveying information (e.g., “Data”). In an exemplary scenario, user 110 may interact with operating system 1220 through operator interface 1222 and other hardware resources 1224. Operating system 1220 may, for example, execute applications that may further utilize the information provided by user 110 (through user interface 1222) when accessing one or both of WLAN radio module 1216 and Bluetooth™ radio module 1218 in order to send and/or receive wireless messages.

Also in FIG. 12, an exemplary Bluetooth™-WLAN coexistence packet traffic arbitration (PTA) interface 1214 is disclosed. In this exemplary configuration, WLAN module 1216 is a primary module including control features for managing at least the use of PHY 1212, and therefore, the operation of any secondary modules sharing this resource, such as Bluetooth™ module 1218. At least four signals may be transmitted on PTA interface 1214. These signals may include RF_ACTWE, which may inform the primary module that a secondary module desires to receive or transmit data; STATUS, which may be used to express a priority or urgency level for a pending communication in a secondary module to the primary module; TX_CONFX may be a message sent from the primary module to the secondary module permitting or denying operation; and FREQ, which may inform the primary module if the secondary module plans to transmit on a restricted channel. More specifically, in a scenario where modules each have their own PHY 1212 (including, for example, their own antennae), that the secondary radio module may be planning to simultaneously transmit on the same frequency as the primary radio module. However, in the exemplary single PHY layer 1212 implementation depicted in FIG. 12, the FREQ signal would not be used since only one radio module can use PHY 1212 at any time.

As set forth above, since WLAN module 1216 and Bluetooth™ module 1218 share a single antenna in the example disclosed in FIG. 12, the FREQ signal would normally not be required during operation. However, since the exemplary shared PHY 1212 disclosed in FIG. 12 is configured so that WLAN radio module 1216 controls the antenna switch (e.g., via the “ctrl” line), the FREQ signal may instead be utilized for another purpose in accordance with at least one embodiment of the present invention. With this signal, Bluetooth™ radio module 1218 may inform WLAN radio module 1216 through PTA interface 1214 (e.g., via the activity/priority line, or “A/P” line as shown in FIG. 12) when it is performing a discovery operation. WLAN radio module 1216 may then receive operational parameters (e.g., period and length of interrupt periods) from, for example, operating system 1220. With these parameters, WLAN radio module 1216 may determine the time periods during which it may interrupt the operation of Bluetooth™ radio module 1218 in order to avoid potential usage conflicts within PHY 1212.

In another exemplary implementation, instead of utilizing the FREQ signal as explained above, the information of a discovery operation for Bluetooth radio module 1218 could be informed to WLAN radio module 1216 by the operating system 1220. Because the Bluetooth inquiry is typically a user originated operation, the operating system 1220 may have knowledge of a coming Bluetooth™ inquiry operation, and it may supply this information to the WLAN radio module 1216. Further, the parameters of interrupt period and length could be provided to the WLAN radio module 1216 from operating system 1220. Similarly, as previously set forth, the WLAN radio module 1216 could then interrupt the operation of the Bluetooth™ radio module 1218 and reserve the antenna for its own use based on the received parameters.

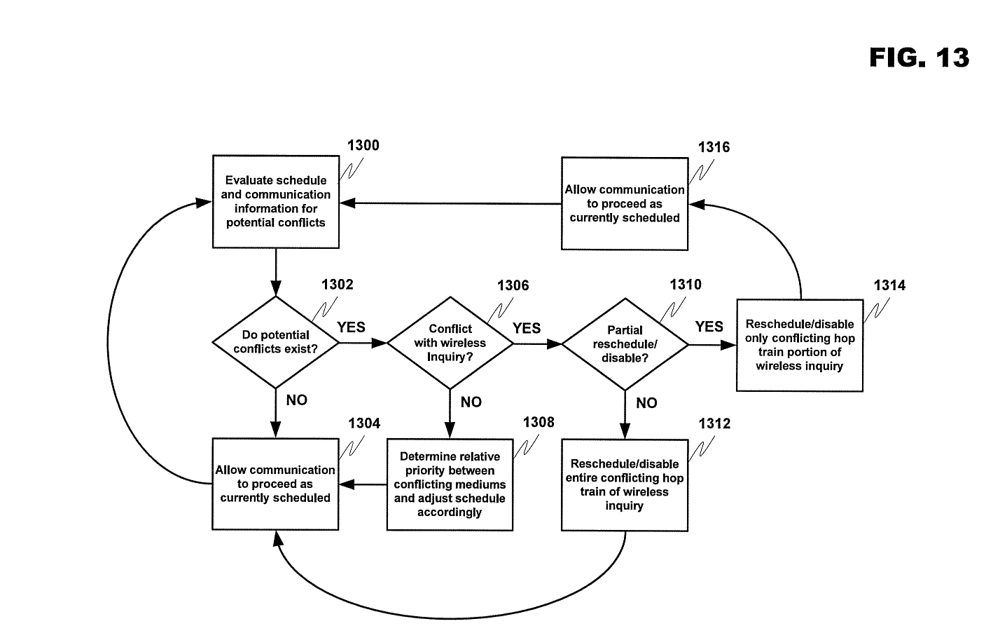

Now referring to FIG. 13, an exemplary process flowchart is now disclosed in accordance with at least one embodiment of the present invention. In step 1300 the operational schedule for two or more wireless communication mediums being supported by one or more radio modules 610 may be evaluated. This evaluation may be completed by control elements in accordance with any of the previously disclosed device configurations, and may include a determination as to whether any of the timeslots reserved in the operational schedules of the active wireless communication mediums will overlap. If no potential conflicts exist in the various operational schedules (step 1302), then communication may be allowed to proceed as currently scheduled in step 1304. This situation may occur, for example, if only one wireless communication medium is active in WCD 100, or alternatively, if all of the active wireless communication mediums are operating in different frequency bands or have alternating (e.g., non-overlapping) reserved activity periods. The operational schedules may then be forwarded to the one or more radio modules 610 over common interface 620 or MCS 700, where they are utilized by local control elements to manage the release of radio module resources to the wireless communication mediums. The process may then return to step 1300 during or after the execution of each operational schedule in the one or more radio modules 610.

If potential conflicts exist in step 1302, then in step 1306 a determination may be made as to whether any of the conflicting wireless communication mediums are operating in a substantially continuous mode (e.g., performing a device discovery or inquiry). If no wireless communication mediums are operating in such a mode, then in step 1308 a relative priority may be determined between the various active communication mediums. Once the relative priority is established, the operational schedules may be reformulated based on these priorities in order to avoid communication conflicts, and communication may then proceed as rescheduled in step 1304 until completed and new operational schedules are formulated and reviewed in step 1300.

If any of the active wireless communication mediums are operating in a substantially continuous mode, then in step 1310 a determination may be made as to whether a partial hop train reschedule/disable of the substantially continuous communication is preferred (if supported by the wireless communication medium and/or its supporting radio module 610) over a reschedule/disable of an entire hop train. Disabling all or part of potentially conflicting hop trains may include a centralized controller (e.g., MRC 600) and/or localized control in a radio module instructing that access to an interface (e.g., a radio modem) be blocked during potentially conflicting periods of time (e.g., timeslots) for any wireless communication medium operating in a substantially continuous mode. If a partial reschedule/disable is not preferred and/or supported, then in step 1312 any conflicting hop train may be disabled in its entirety and then be rescheduled at a later time. The reformulated schedules may then be allowed to proceed in step 1304 until completed, followed by the process restarting in step 1300. Otherwise, if partial hop train rescheduling/disabling is both supported and preferred, then in step 1314 only timeslots that conflict with other wireless communication mediums are rescheduled/disabled.

In a scenario where partial hop train rescheduling/disabling is both supported and preferred, a canceled timeslot in a hop train may correspond to, for example, the scanning of a particular frequency that is in use by another wireless communication medium during the timeslot. In an extreme case, the timeslots pertaining to the scan of a problematic frequency may be rescheduled/disabled in each subsequent train in order to avoid potential communication conflicts. It may also be possible for timeslots corresponding to a problematic frequency, or frequencies, to be rescheduled/disabled every other train, every three trains, etc. if, for example, the period of the interfering wireless communication medium is longer that the period of each scan train. Regardless, in order to ensure that all frequencies are scanned by WCD 100, any timeslots that were disabled may be rescheduled at a later time when no potential conflicts exist. Overall, the reschedule/disable strategy helps to ensure that all of the operational frequencies are eventually scanned, while simultaneously avoiding potential communication conflicts with other wireless communication mediums. Any schedules that are reformulated may then be allowed to proceed in step 1316 until the communication is completed, followed by the process restarting in step 1300.

Accordingly, it will be apparent to persons skilled in the relevant art that various changes in forma and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method, comprising:
determining if at least one wireless communication medium out of a plurality of wireless communication mediums is operating in a discovery mode, the plurality of wireless communication mediums being supported by one or more radio modules integrated within a wireless communication device;
determining whether any potential conflict periods exist between the plurality of wireless communication mediums and the discovery operation; and
if any potential conflict periods exist, instructing the one or more radio modules supporting the at least one wireless communication medium operating in a discovery mode to disable the discovery operation during the conflict periods.

2. The method of claim 1, wherein determining if any potential conflict periods exist comprises comparing operational schedules for the plurality of wireless communication mediums to the discovery operation.

3. The method of claim 2, wherein the operational schedules are compared by a multiradio controller integrated within the wireless communication device.

4. The method of claim 1, wherein instructing the one or more radio modules further comprises setting the at least one wireless communication medium operating in a discovery mode to a lower priority than other wireless communication mediums.

5. The method of claim 1, wherein the discovery operation is composed of a plurality of timeslots, the timeslots corresponding to periods of time during which discovery scans corresponding to certain frequencies are predicted to occur.

6. The method of claim 5, wherein disabling the discovery operation further comprises canceling only timeslots that conflict with other wireless communication mediums, a conflict being identified as any timeslot during which a discovery scan is predicted to occur on a frequency being used by another wireless communication medium.

7. The method of claim 5, wherein disabling the discovery operation further comprises canceling entire hop trains that include timeslots that are predicted to conflict with other wireless communication mediums.

8. The method of claim 1, further comprising rescheduling any canceled portion of an inquiry to occur at a later time.

9. A computer program product comprising a computer usable medium having computer readable program code embodied in said medium, comprising:
a computer readable program code configured to determine if at least one wireless communication medium out of a plurality of wireless communication mediums is operating in a discovery mode, the plurality of wireless communication mediums being supported by one or more radio modules integrated within a wireless communication device;
a computer readable program code configured to determine whether any potential conflict periods exist between the plurality of wireless communication mediums and the discovery operation; and
a computer readable program code configured to, if any potential conflict periods exist, instruct the one or more radio modules supporting the at least one wireless communication medium operating in a discovery mode to disable the discovery operation during the conflict periods.

10. The computer program product of claim 9, wherein determining if any potential conflict periods exist comprises comparing operational schedules for the plurality of wireless communication mediums to the discovery operation.

11. The computer program product of claim 9, wherein the operational schedules are compared by a multiradio controller integrated within the wireless communication device.

12. The computer program product of claim 9, wherein instructing the one or more radio modules further comprises setting the at least one wireless communication medium operating in a discovery mode to a lower priority than other wireless communication mediums.

13. The computer program product of claim 9, wherein the discovery operation is composed of a plurality of timeslots, the timeslots corresponding to periods of time during which discovery scans corresponding to certain frequencies are predicted to occur.

14. The computer program product of claim 13, wherein disabling the discovery operation further comprises canceling only timeslots that conflict with other wireless communication mediums, a conflict being identified as any timeslot during which a discovery scan is predicted to occur on a frequency being used by another wireless communication medium.

15. The computer program product of claim 13, wherein disabling the discovery operation further comprises canceling entire hop trains that include timeslots that are predicted to conflict with other wireless communication mediums.

16. The computer program product of claim 9, further comprising rescheduling any canceled portion of an inquiry to occur at a later time.

17. A device, comprising:
at least one processor;
one or more radio modules configured to support a plurality of wireless communication mediums, the one or more radio modules being coupled to the at least one processor;
wherein the device is configured to:
determine if at least one wireless communication medium out of the plurality of wireless communication mediums is operating in a discovery mode;
determine if any potential conflict periods exist between the plurality of wireless communication mediums and the discovery operation; and
if any potential conflict periods exist, instruct the one or more radio modules supporting the at least one wireless communication medium operating in a discovery mode to disable the discovery operation during the conflict periods.

18. The device of claim 17, further comprising a multiradio control module coupled to the at least one processor and the one or more radio modules.

19. The device of claim 18, wherein the multiradio control module is configured to control the one or more radio modules, including formulating operational schedules for the plurality of wireless communication mediums.

20. The device of claim 19, wherein the multiradio control module, the at least one processor and the one or more radio modules are coupled by a communication bus dedicated to conveying delay-sensitive communication.

21. A device, comprising:
means for determining if at least one wireless communication medium out of a plurality of wireless communication mediums is operating in a discovery mode, the plurality of wireless communication mediums being supported by one or more radio modules integrated within a wireless communication device;
means for determining whether any potential conflict periods exist between the plurality of wireless communication mediums and the discovery operation; and
means for, if any potential conflict periods exist, instructing the one or more radio modules supporting the at least one wireless communication medium operating in a discovery mode to disable the discovery operation during the conflict periods.

22. The device of claim 21, further comprising a multiradio control module coupled to the at least one processor and the one or more radio modules.

23. The device of claim 22, wherein the multiradio control module is configured to control the one or more radio modules, including formulating operational schedules for the wireless communication mediums.

24. The device of claim 23, wherein the multiradio control module, the at least one processor and the one or more radio modules are coupled by a communication bus dedicated to conveying delay-sensitive communication.

25. A multiradio controller, comprising:
at least one processing module;
at least one common interface module coupled to the at least one processor module; and
at least one interface dedicated to conveying delay-sensitive communication coupled to the at least one processor module;
wherein the controller is configured to:
determine if at least one wireless communication medium out of a plurality of wireless communication mediums is operating in a discovery mode, the plurality of wireless communication mediums being supported by one or more radio modules integrated within a wireless communication device;
determine whether any potential conflict periods exist between the plurality of wireless communication mediums and the discovery operation; and
if any potential conflicts exist, instruct the one or more radio modules supporting the at least one wireless communication medium operating in a discovery mode to disable the discovery operation during the conflict periods.

26. A radio module, comprising:
one or more radio modems configured to support one or more wireless communication mediums; and
at least one interface module coupled to the one or more radio modems;
wherein the radio module is configured to:
receive, via the at least one interface module, operational schedule information related to the one or more wireless communication mediums for controlling the operation of the one or more wireless communication mediums; and
if the radio module supports at least one wireless communication medium operating in a discovery mode, receive, via the at least one interface module, control information for disabling the at least one wireless communication medium operating in a discovery mode during potential conflict periods.

27. The radio module of claim 26, wherein the at least one interface module is further utilized to indicate to a multiradio controller that the radio module is initiating a discovery operation for at least one wireless communication medium.

28. A chipset, comprising:
at least one processing module;
one or more radio modules configured to support a plurality of wireless communication mediums, the one or more radio modules being coupled to the at least one processing module;
wherein the chipset is configured to:
determine if at least one wireless communication medium out of a plurality of wireless communication mediums is operating in a discovery mode;
determine whether any potential conflict periods exist between the plurality of wireless communication mediums and the discovery operation; and
if any potential conflicts exist, instruct the one or more radio modules supporting the at least one wireless communication medium operating in a discovery mode to disable the discovery operation during the conflict periods.

29. The chipset of claim 28, further comprising a multiradio control module coupled to the at least one processor and the one or more radio modules.

30. A method, comprising:
determining if at least one wireless communication medium out of a plurality of wireless communication mediums is operating in a discovery mode, the plurality of wireless communication mediums being supported by one or more radio modules integrated within a wireless communication device;
determining whether any potential conflict periods exist between the plurality of wireless communication mediums and the discovery operation; and
if any potential conflict periods exist, disabling the discovery operation during the conflict periods by enforcing blocking of access to a wireless communication interface for the one or more radio modules supporting the at least one wireless communication medium operating in the discovery mode.

31. A controller, comprising:
at least one processing module; and
at least one interface module coupled to the at least one processor module;
wherein the controller is configured to:
determine if at least one wireless communication medium out of a plurality of wireless communication mediums is operating in a discovery mode, the plurality of wireless communication mediums being supported by one or more radio modules integrated within a wireless communication device;
determine whether any potential conflict periods exist between the plurality of wireless communication mediums and the discovery operation; and
if any potential conflict periods exist, disable the discovery operation during the conflict periods by enforcing blocking of access to a wireless communication interface for the one or more radio modules supporting the at least one wireless communication medium operating in the discovery mode.

32. A device, comprising:
at least one processor;
one or more radio modules configured to support a plurality of wireless communication mediums, the one or more radio modules being coupled to the at least one processor;
wherein the device is configured to:
determine if at least one wireless communication medium out of a plurality of wireless communication mediums is operating in a discovery mode;
determine whether any potential conflict periods exist between the plurality of wireless communication mediums and the discovery operation; and
if any potential conflict periods exist, disable the discovery operation during the conflict periods by enforcing blocking of access to a wireless communication interface for the one or more radio modules supporting the at least one wireless communication medium operating in the discovery mode.

33. A system, comprising:
a wireless communication device, the wireless communication device further comprising one or more radio modules for supporting a plurality of wireless communication mediums; and
a multiradio controller coupled to the one or more radio modules;
the multiradio controller determining if at least one wireless communication medium out of a plurality of wireless communication mediums is operating in a discovery mode;
the multiradio controller determining whether any potential conflict periods exist between the plurality of wireless communication mediums and the discovery operation; and
if any potential conflicts exist, the multiradio controller instructing the one or more radio modules supporting the at least one wireless communication medium operating in a discovery mode to disable the discovery operation during the conflict periods.
